(19) United States
(12) Patent Application Publication
(10) Pub. No.: US 2007/0134804 A1
(43) Pub. Date: Jun. 14, 2007

(54) Method of characterizing a dispersion using transformation techniques

(75) Inventors: Douglas B. Fisher, Calgary (CA); Marcel Girard, Calgary (CA); Haibo Huang, Edmonton (CA)

Correspondence Address: RODMAN RODMAN, 7 SOUTH BROADWAY, WHITE PLAINS, NY, 10601, US

(73) Assignee: Alberta Research Council Inc., Edmonton, Alberta (CA)

(21) Appl. No.: 10/574,767

(22) PCT Filed: Oct. 12, 2004
(86) PCT No.: PCT/CA04/01820

§ 371 Date: Aug. 18, 2006

(30) Foreign Application Priority Data
Oct. 17, 2003 (CA) 2445426

(51) Int. Cl. G06F 19/00; G01N 21/00

(52) U.S. Cl. 436/164; 702/22

(57) ABSTRACT

A method for analyzing a dispersion such as an oil/solid suspension or an oil/water emulsion. A set of original domain data is collected relating to an attribute of the dispersion, such as light transmittance therethrough. The set of original domain data is then transformed into a transformed set of original domain data which is in the frequency domain. Any transformation technique, such as a fast Fourier transform, may be used to transform the original domain data from a first domain, such as a time or spatial domain, into the frequency domain. The dispersion is then characterized using the transformed set of original domain data. One or more frequency domain spectra may be generated from the transformed set of original domain data, which frequency domain spectra express a parameter relating to the attribute of the dispersion as a function of frequency, in which case the characterizing step may be performed using the frequency domain spectra.

### FIELD OF INVENTION

The present invention relates to a method for analyzing a dispersion, including a suspension or an emulsion, utilizing original domain data transformed into the frequency domain.

### BACKGROUND OF INVENTION

The analysis or study of the behaviour of various dispersions has been undertaken in many fields and industries. Generally speaking, this analysis or study is often performed in an attempt to obtain information relating to the character or nature of a particular dispersion under selected or defined conditions.

This information may then be used for numerous purposes including the optimization or enhancement of the composition of a particular dispersion to be used in the defined conditions or the optimization or enhancement of the conditions to which the particular dispersion will be exposed depending upon the desired result or effect. In other words, the information may be used to alter either or both of the dispersion or the conditions to which it is exposed in order to achieve a specific desired result.

For instance, the analysis of emulsions may be undertaken in order to determine the stability of a particular emulsion composition under varying conditions. In particular, this analysis may reveal the conditions under which the emulsion will undergo coalescing or separation.

Similarly, the analysis of liquid-solid suspensions may be undertaken in order to determine the conditions under which the solid particles will undergo precipitation, flocculation or agglomeration, or deposition. For example, in the oil and gas industry, including heavy oil production processes and Improved Oil Recovery (IOR) or enhanced recovery processes, asphaltenes contained within the crude oil may destabilize and precipitate under varying pressure, temperature or compositional changes during production. As the asphaltene particles agglomerate and grow in size, deposition may occur within the production equipment causing difficulties or problems in the production process. These problems or difficulties may increase with the use of solvents in IOR processes, which solvents may tend to destabilize the dispersion and cause or increase the likelihood of precipitation of the asphaltenes from the crude oil and subsequent deposition in the production equipment.

Thus, the use of miscible solvents in IOR processes requires knowledge of how the solvent will behave over all mixing ratios or concentrations of crude oil and solvent. In particular, it is desirable to determine the conditions under which the asphaltenes will start to precipitate and the conditions that will cause the asphaltene particles to flocculate or agglomerate and eventually deposit in the reservoir pore network. These conditions may relate to solvent concentration, pressure, temperature, or to some other variable.

In other words, the information obtained relating to the character, behaviour or nature of the asphaltenes in the dispersion may be used to assist in the prediction of production/injection performance and the prediction and avoidance of different operational problems related to asphaltene deposition in miscible solvent injections, such as CO₂ miscible injections and also CO₂ sequestration processes in depleted oil reservoirs.

Understanding the phenomena related to asphaltene precipitation, flocculation and deposition is of significant interest in the application of miscible CO₂ flooding. Previous studies (A. Turta, D. Fisher, A. K. Singal, J. Najman, “Variation of Oil-solvent Mixture Viscosity in Relation to the Onset of Asphaltene Flocculation and Deposition”, Special Edition Journal of Canadian Petroleum Technology 38, No. 13 Paper: 97-81, 1999) have shown that with proper equipment it is possible to study asphaltene/solvent behavior under reservoir conditions, for a range of crude oils, without resorting to dilution of the oil with an aromatic solvent such as toluene.

Many different approaches have been taken to determining or monitoring the content of particulate material in a fluid, and particularly analyzing or determining the content of insolubles in oils, such as asphaltenes, to assess the stability of the dispersion.

For example, A. K. M. Jamaluddin et. al., “A Comparison of Various Laboratory Techniques to Measure Thermodynamic Asphaltene Stability”, Society of Petroleum Engineers, SPE Paper Number 72154, 2001 attempts to identify the first pressure and/or temperature conditions at which asphaltenes will begin to precipitate in crude oils. Specifically, four techniques are independently used to define the onset of the asphaltene precipitation envelope: gravimetric; acoustic resonance; light scattering; and filtration. The relative advantages or merits and disadvantages or demerits of each technique are discussed.

A further approach to determining the content of insoluble particulate material in a fluid utilizes a measurement of the scattering or the absorbence or transmittance of a transmitted light through a fluid sample. Alternatively, a fluid sample may be circulated through a transilluminated or irradiated cell, wherein images of the illuminated or irradiated fluid sample are recorded for subsequent analysis. Examples of these approaches are provided by: U.S. Pat. No. 5,719,665 issued Feb. 17, 1998 to Yamazoe; PCT International Publication No. WO 99/51963 published Oct. 14, 1999 by Norsk Hydro ASA; PCT Publication No. WO 00/46586 published Aug. 10, 2000 by Jorin Limited; and U.S. Publication No. 2002/0105645 A1 published Aug. 8, 2002 by Eriksson. However, each of these references provides only a limited analysis of the collected data and a limited characterization of the fluid sample.

However, none of the above approaches has been found to be fully satisfactory. Therefore, there remains a need for an improved method for analyzing a dispersion which provides accurate and reliable results in comparison with other available methods.

### SUMMARY OF THE INVENTION

The present invention relates to a method and apparatus for analyzing a dispersion. The analysis of the dispersion may be made for the purpose of characterizing the dispersion with respect to one or more properties or characteristics of the dispersion. The invention is particularly suited for characterizing the dispersion with respect to a dispersion characterizing variable as the dispersion characterizing variable is varied.

In one aspect, the invention is a method for analyzing a dispersion comprising the following steps:
(a) collecting a set of original domain data relating to an attribute of the dispersion;
(b) transforming the set of original domain data into a transformed set of original domain data, wherein the transformed set of original domain data is in the frequency domain; and
(c) characterizing the dispersion using the transformed set of original domain data.

The dispersion may be comprised of any system in which one or more dispersed phases are distributed throughout a dispersion medium. The dispersed phase and the dispersion medium may both be comprised of one or more solids, liquids or gases. The dispersion medium and the dispersed phase or phases may be comprised of one or more substances. Preferably the dispersion medium is a liquid phase.

In some preferred embodiments, the dispersion is comprised either of solid particles as a dispersed phase within a liquid dispersion medium or an emulsion in which both the dispersed phase and the dispersion medium are liquids.

In one preferred embodiment, the dispersion is comprised of a suspension comprising oil and solvent as a dispersion medium, in which case a dispersed phase of interest may be solid asphaltene particles. In this preferred embodiment, the method of the invention may be used to characterize the dispersion with respect to the precipitation, agglomeration and deposition of solid asphaltene particles as a dispersion characterizing variable is varied. The dispersion characterizing variable may be time, concentration of solvent which is mixed with the oil, pressure, temperature or some other variable which is relevant to the characterization of the dispersion.

In a second preferred embodiment, the dispersion may be comprised of an emulsion, such as an oil and water emulsion, and the dispersed phase of interest may either be oil or water. In this preferred embodiment, the method of the invention may be used to characterize the emulsion with respect to its drying properties. Alternatively, the method of the invention may be used to characterize the emulsion with respect to its stability (i.e., the tendency for coalescing and separation of the dispersed phase) as a dispersion characterizing variable is varied. In this embodiment, the dispersion characterizing variable may be time, relative proportions of dispersion mediums and dispersed phases, temperature, pressure or some other variable which is relevant to the characterization of the emulsion.

The set of original domain data may be in any domain which is capable of being transformed into the frequency domain. Preferably the set of original domain data is in the time domain or the space domain.

In one preferred embodiment, the set of original domain data is in the time domain so that the set of original domain data is comprised of an attribute signal which represents values for the attribute over a period of time. In a second preferred embodiment, the set of original domain data is in the space domain so that the set of original domain data is comprised of an attribute image which represents values for the attribute over a spatial area.

Preferably the attribute image represents values for the attribute over the spatial area at a particular point in time. Alternatively, the attribute image may be comprised of a plurality of attribute signals which are generated over the spatial area.

The collecting step is preferably performed using a data collection apparatus. Preferably the data collection apparatus is comprised of an attribute sensor. Where the set of original domain data is in the time domain the attribute sensor may be comprised of any sensing device or apparatus which is capable of sensing the attribute signal. Where the set of original data is in the space domain the attribute sensor may be comprised of a plurality of sensors arranged over the spatial area or the attribute sensor may be comprised of an image gathering device such as a camera.

Where the set of original domain data is in the time domain, the method of the invention preferably further comprises the step of manipulating the dispersion during the period of time of the attribute signal in order to cause variations in the attribute signal over the period of time.

More preferably, the manipulating step is preferably comprised of moving the dispersion through a conduit past the attribute sensor so that the set of original domain data provides a “time of flight” attribute signal as the dispersion moves past the attribute sensor.

The attribute of the dispersion may be comprised of any measurable characteristic of the dispersion. For example, the attribute may be comprised of pressure of the dispersion, viscosity of the dispersion, density of the dispersion, electrical conductivity of the dispersion, sonic transmittance of the dispersion, transmittance, absorption or scattering of electromagnetic radiation through the dispersion or even the nuclear magnetic resonance characteristics of the dispersion. The set of original domain data relates to the attribute.

In one preferred embodiment, the attribute is transmittance of electromagnetic radiation through the dispersion so that the set of original domain data relates to variations in transmittance through the dispersion. The electromagnetic radiation may be comprised of radiation of any wavelength which is capable of exhibiting transmittance through the dispersion. Preferably the wavelength of the electromagnetic radiation is selected having regard to the characteristics of the dispersion. For example, where the dispersion is comprised of oil, particularly crude oil, wavelengths within the infrared portion of the electromagnetic spectrum may be preferred.

Where the attribute is transmittance of electromagnetic radiation, the set of original domain data may be collected in any suitable domain. In preferred embodiments, the set of original domain data is comprised either of a transmittance signal representing transmittance of electromagnetic radiation tough the dispersion over time of a transmittance image representing distribution of transmittance of electromagnetic radiation through the dispersion over a spatial area.

Where the attribute is transmittance of electromagnetic radiation, the attribute sensor is preferably comprised of a transmittance sensor, the data collection apparatus is preferably further comprised of a source of electromagnetic radiation, and the manipulating step is preferably comprised of moving the dispersion through the conduit between the source of electromagnetic radiation and the transmittance sensor.

Where the attribute is transmittance of electromagnetic radiation and the set of original domain data is in the space domain, the attribute sensor is preferably comprised of an image gathering device such as a camera.

In a second preferred embodiment, the attribute is pressure of the dispersion so that the set of original domain data relates to pressure transients experienced by the dispersion. Where the attribute is pressure of the dispersion, the, set of original domain data may be collected in any suitable domain. In a preferred embodiment the set of original domain data is comprised of a pressure signal representing pressure transients experienced by the dispersion over time. Alternatively, the set of original domain data may be comprised of an image representing distribution of pressure of the dispersion over a spatial area In either case, variations in pressure may be exhibited by the dispersion due to variable energy losses as the dispersion is moved along a flowpath or through a conduit.

The set of original domain data may be transformed into the transformed set of original domain data in any manner such that the transformed set of original domain data is in the frequency domain. For example the transforming step may utilize methods such as the Fourier transform (FT) method, fast Fourier transform (FFT) method, maximum entropy method, free cosine transform method, discrete cosine transform method and wavelength analysis method. In the preferred embodiment the transforming step is performed using either the fast Fourier transform method or the maximum entropy method.

Depending upon the nature of the set of original domain data, the set of original domain data may be transformed into the frequency domain using either a one dimensional transform or a two dimensional transform method.

As a first example, the set of original domain data may be expressed as an attribute signal in one dimension, wherein the attribute signal represents the attribute as a function of the original domain in one dimension. In this case, the set of original domain data may be transformed into the frequency domain using a one dimensional transform. In preferred embodiments the set of original domain data may be expressed as a transmittance signal in one dimension in the time domain or as a pressure signal in one dimension in the time domain, which may then be transformed into the frequency domain using a one dimensional transform method.

As a second example, the set of original domain data may also be expressed as an attribute image in two dimensions, wherein the attribute image represents the attribute as a function of the original domain in two dimensions. In this case, the set of original domain data may be transformed into the frequency domain using a two dimensional transform. In preferred embodiments the set of original domain data may be expressed as a two dimensional transmittance image in the space domain which may then be transformed into the frequency domain using a two dimensional transform method.

As a third example, an attribute image in two dimensions may be expressed as an attribute signal in one dimension in the space domain by generating a “signal” in the space domain along a one dimensional sample line through the two dimensional attribute image.

In preferred embodiments the set of original domain data may be expressed as a plurality of one dimensional sample line transmittance signals through a two dimensional transmittance image, and each of these transmittance signals can be separately transformed into the frequency domain. The separate transformations of these transmittance signals may then be processed to generate a single one dimensional set of transformed original domain data which is representative of the two dimensional transmittance image. The separate transformations may be processed using any suitable method, including for example by simple averaging of the separate transformations as a function of frequency.

The transformed set of original domain data is used to characterize the dispersion. The set of original domain data may be comprised of a single subset of original domain data so that the transformed set of original domain data is also comprised of a single subset or transformed original domain data. The transformed set of original domain data may then be used to characterize the dispersion under a single set of conditions.

Preferably, however, the collecting step is comprised of collecting a plurality of subsets of original domain data so that the set of original domain data is comprised of the subsets of original domain data, and preferably the subsets of original domain data are transformed into a plurality of subsets of transformed original domain data. As a result, the characterizing step is preferably performed using the subsets of transformed original domain data. The use of a plurality of subsets of transformed original domain data to characterize the dispersion facilitates characterizing of the dispersion under differing sets of conditions.

Preferably the collecting step is comprised of collecting each of the subsets of original domain data at a different value of a dispersion characterizing variable so that the dispersion may be characterized with respect to the dispersion characterizing variable. This facilitates characterizing of the dispersion under differing sets of conditions as defined by the variation in the dispersion characterizing variable.

The dispersion characterizing variable may be any variable relating to the dispersion which when varied may affect the properties or characteristics of the dispersion. For example, the dispersion characterizing variable may relate to the temperature, pressure or composition of the dispersion or elapsed time. The dispersion characterizing variable may be comprised of a single variable or may be comprised of a combination of variables.

In the preferred embodiments where the dispersion is a suspension comprising oil and asphaltene particles, the dispersion characterizing variable is preferably solvent concentration in the dispersion medium, time, pressure or temperature, since each of these variables may affect the precipitation, agglomeration and deposition characteristics of such suspensions. The solvent may be any suitable solvent, including hydrocarbons and non-hydrocarbons. In preferred embodiments the method of the invention has been applied to oil suspensions in which the solvent is comprised of pentane or carbon dioxide.

In the preferred embodiments where the dispersion is an emulsion such as an oil and water emulsion, the dispersion characterizing variable is preferably time, relative proportions of the dispersion medium and the dispersed phase in the suspension, pressure of the suspension, or kinetic energy of the suspension as it is transported. The use of time as the dispersion characterizing variable is advantageous where the drying properties of the emulsion are being characterized. The use of relative proportions of the dispersion medium and the dispersed phase, pressure of the suspension or kinetic energy of the suspension as the dispersion characterizing variable is advantageous where the stability properties of the emulsion are being characterized.

The transformed set of original domain data may be used in any suitable format which facilitates characterizing of the dispersion in the characterizing step. Preferably, however, a frequency domain spectrum is generated from the transformed set of original domain data, wherein the frequency domain spectrum expresses a parameter relating to the attribute of the dispersion as a function of frequency, and the characterizing step is performed using the frequency domain spectrum.

The parameter relating to the attribute of the dispersion may be any parameter which is indicative of the attribute. For example, the parameter may represent amplitude, magnitude or power of the attribute. In the preferred embodiments the parameter is power of the attribute.

Where the set of transformed original domain data is comprised of a plurality of subsets of transformed original domain data, each relating to a different value for the dispersion characterizing variable, the step of generating a frequency domain spectrum from the transformed set of original domain data preferably comprised of generating a frequency domain spectrum from each of the subsets of transformed original domain data in order to produce a plurality of frequency domain spectra, and the characterizing step is preferably performed using the plurality of frequency domain spectra so that the dispersion can be characterized with respect to the dispersion characterizing variable.

The set of original domain data may be transformed directly from the original domain into the frequency domain. Preferably, however, the set of original domain data is subjected to a conditioning step before the transforming step in order to reduce at least one unwanted component in the set of original domain data. The unwanted component or components may include a DC component included in the set of original domain data or a low frequency component included in the set of original domain data.

The conditioning step may be comprised of any suitable data conditioning method for reducing either or both of the DC component and the low frequency component.

One preferred data conditioning method is the application to the set of original domain data of a locally weighted least squares method (such as the locally weighted average value method). This data conditioning method is particularly suited to one dimensional attribute signals or images and may be effective to reduce or remove both the DC component and the low frequency component from the set of original domain data Alternatively, the data conditioning method may be comprised of calculating a derivative of the set of original domain data Where the transforming step is comprised of a one dimensional transform into the frequency domain, the derivative is preferably calculated in one dimension. Where the transforming step is comprised of a two dimensional transform into the frequency domain, the derivative is preferably calculated in two dimensions. Where the derivative is calculated in two dimensions, the derivative is preferably calculated using a Laplacian operation.

This alternative data conditioning method is particularly suited to two dimensional attribute images and may be effective to reduce or remove the DC component from the set of original domain data, but less effective for reducing or removing the low frequency component from the set of original domain data.

The characterizing step may be comprised of any data processing or signal processing method or technique which facilitates the characterization of the dispersion using the transformed set of original domain data. Preferably the characterizing step is performed using a frequency domain spectrum or a plurality of frequency domain spectra.

In a first preferred frequency domain spectra processing method where the dispersion is characterized with respect to a dispersion characterizing variable, the characterizing step is comprised of the step of generating from a plurality of frequency domain spectra an expression of the parameter relating to the attribute of the dispersion as a function of both frequency and the dispersion characterizing variable. This expression of three variables may be presented in any suitable manner, including as a three axis graphical representation or as a three dimensional map representation. Optionally, the representation of the expression of the three variables may be normalized or otherwise processed using statistical curve fitting tools in order to reduce the effects of aberrations in the data.

Once the expression of the three variables has been obtained and presented in a suitable manner, the characterizing step may be completed by observing contours and trends of the expression, which contours and trends can be linked to properties or characteristics of the dispersion as a function of the dispersion characterizing variable.

The first preferred frequency domain spectra processing method is suitable for use in processing one dimensional transforms of a set of original domain data, since the two dimensions from the one dimensional transforms may easily be presented as a function of the dispersion characterizing variable. The first preferred frequency domain spectra processing method is not generally suitable for use in processing two dimensional transforms of a set of original domain data, since the three dimensions from the two dimensional transforms are not easily presented as a function of the dispersion characterizing variable.

In a second preferred frequency domain spectra processing method where the dispersion is characterized with respect to a dispersion characterizing variable, the characterizing step is comprised of the step of integrating each of the frequency domain spectra between an upper selected frequency and a lower selected frequency, thereby obtaining a characterization number for each of the frequency domain spectra.

The upper selected frequency and the lower selected frequency are selected having regard to the goals of the characterizing step. As a result, the upper selected frequency and the lower selected frequency may be comprised of any region of interest in the frequency domain spectra. As one example, where a particular range of frequencies exhibits a transient or transients in the value of the parameter relating to the attribute, the upper selected frequency and the lower selected frequency may be selected to correspond with this range of frequencies. As a second example, the upper selected frequency and the lower selected frequency may be selected to correspond with the entire range of frequencies contained in the frequency domain spectra. Preferably the upper selected frequency and the lower selected frequency are selected to be the same for each of the frequency domain spectra.

The characterizing step may then be further comprised of the step of generating from the characterization numbers an expression of characterization number as a function of the dispersion characterizing variable. This expression of two variables may be presented in any suitable manner, including as a two axis graphical representation comprising a characterization number curve.

Finally, the characterizing step may optionally be further comprised of calculating a derivative of the expression of characterization number as a function of the dispersion characterizing variable in order to obtain an expression of characterization number gradient as a function of dispersion characterizing variable. This expression of characterization number gradient may be presented in any suitable manner, including as a two axis graphical representation comprising a characterization number gradient curve. The characterization number gradient curve will provide an expression of the slope of the characterization number curve.

Optionally, the characterization number curve and the characterization number gradient curve may be normalized or otherwise processed using statistical curve fitting tools in order to reduce the effects of aberrations in the data.

Once the expression of characterization number as a function of the dispersion characterizing variable has been obtained and suitably presented, the characterizing step may be completed by observing trends in the characterization number curve, which trends can be linked to properties or characteristics of the dispersion as a function of the dispersion characterizing variable. Similarly, once the derivative of the expression of characterization number as a function of the dispersion characterizing variable has been calculated, the characterizing step may be completed by observing trends in the characterization number gradient curve, which trends can also be linked to properties or characteristics of the dispersion as a function of the dispersion characterizing variable.

The second preferred frequency domain spectra processing method is suitable for use in processing either one dimensional transforms or two dimensional transforms of a set of original domain data. Where the second preferred frequency domain spectra processing method is used in processing one dimensional transforms of a set of original domain data, the resulting characterization numbers are effectively an expression of area. Where the second preferred frequency domain spectra processing method is used in processing two dimensional transforms of a set of original domain data, the resulting characterization numbers are effectively an expression of volume.

### SUMMARY OF DRAWINGS

Embodiments of the invention will now be described with reference to the accompanying drawings, in which:

FIG. 1 is a schematic drawing depicting a preferred embodiment of a test apparatus according to the invention for analyzing the precipitation, agglomeration and deposition of asphaltenes contained in oil samples as a function of concentration of a solvent;

FIG. 2 is a schematic drawing depicting a preferred configuration of a test spectrophotometer apparatus according to the preferred embodiment of FIG. 1;

FIG. 3 is a graphical representation of a typical sequence of frequency domain power spectra derived from oil sample data obtained using a test spectrophotometer apparatus of the type shown in FIG. 2, in which the X-axis represents pentane solvent ratio, the Y-axis represents temporal frequency and the Z-axis represents power;

FIG. 4 is a schematic drawing depicting a preferred configuration of a test micro visual cell apparatus according to the preferred embodiment of FIG. 1;

FIG. 5 is a typical light transmittance image obtained using a test micro visual cell apparatus of the type shown in FIG. 4 depicting light transmittance through an oil sample;

FIG. 6 is a set of four typical light transmittance images obtained using a test micro visual cell apparatus of the type shown in FIG. 4 depicting oil samples containing different amounts of pentane solvent, in which the light transmittance intensity range has been optimized for each of the images;

FIG. 7 is a light transmittance image pertaining to an oil sample containing no pentane solvent, obtained using a test micro visual cell apparatus of the type shown in FIG. 4 and indicating the location of a one dimensional sample line extending along the X-axis of the image;

FIG. 8 is a graphical representation of a light transmittance signal through the light transmittance image of FIG. 7 along the sample line depicted in FIG. 7, in which the X-axis represents the horizontal position along the sample line and the Y-axis represents the intensity of light transmittance at a particular horizontal position;

FIG. 9 is a one dimensional frequency domain power spectrum derived from the light transmittance signal of FIG. 8, in which the X-axis represents spatial frequency and the Y-axis represents power;

FIG. 10 is a light transmittance image pertaining to an oil sample containing a relatively low concentration of pentane solvent, obtained using a test micro visual cell apparatus of the type shown in FIG. 4 and indicating the location of a one dimensional sample line extending along the X-axis of the imaged;

FIG. 11 is a graphical representation of a light transmittance signal through the light transmittance image of FIG. 10 along the sample line depicted in FIG. 10, in which the X-axis represents the horizontal position along the sample line and the Y-axis represents the intensity of light transmittance at a particular horizontal position;

FIG. 12 is a one dimensional frequency domain power spectrum derived from the light transmittance signal of FIG. 11, in which the X-axis represents spatial frequency and the Y-axis represents power;

FIG. 13 is a light transmittance image pertaining to an oil sample containing a higher concentration of pentane solvent than the light transmittance image of FIG. 10, obtained using a test micro visual cell apparatus of the type shown in FIG. 4 and indicating the location of a one dimensional sample line extending along the X-axis of the image;

FIG. 14 is a graphical representation of a light transmittance signal through the light transmittance image of FIG. 13 along the sample line depicted in FIG. 13, in which the X-axis represents the horizontal position along the sample line and the Y-axis represents the intensity of light transmittance at a particular horizontal position;

FIG. 15 is a one dimensional frequency domain power spectrum derived from the light transmittance signal of FIG. 14, in which the X-axis represents spatial frequency and the Y-axis represents power;

FIG. 16 is a graphical representation of a light transmittance signal through a sample of toluene along a sample line in a light transmittance image (not shown), in which the X-axis represents the horizontal position along the sample line and the Y-axis represents the intensity of light transmittance at a particular horizontal position;

FIG. 17 is a one dimensional frequency domain power spectrum derived from the light transmittance signal of FIG. 16, in which the X-axis represents spatial frequency and the Y-axis represents power;

FIG. 18 is a graphical representation of a typical sequence of one dimensional frequency domain power spectra derived from oil sample data obtained using a test micro visual cell apparatus of the type shown in FIG. 4, in which the X-axis represents pentane solvent ratio, the Y-axis represents spatial frequency and the Z-axis represents power, together with an overlay curve in which the X-axis represents pentane solvent ratio and the Y-axis represents characterization number;

FIG. 19 is a light transmittance intensity histogram derived from the light transmittance image which is inset in FIG. 19 for an oil sample containing a minimal amount of precipitated asphaltene particles, in which the X-axis represents light transmittance intensity, the Y-axis represents frequency of a particular light transmittance intensity throughout the light transmittance image and the two curves represent modal intensity of liquid and solid phases;

FIG. 20 is a light transmittance intensity histogram derived from the light transmittance image which is inset in FIG. 20 for an oil sample containing some precipitated asphaltene particles, in which the X-axis represents light transmittance intensity, the Y-axis represents frequency of a particular light transmittance intensity throughout the light transmittance image and the two curves represent modal intensity of liquid and solid phases;

FIG. 21 is a light transmittance intensity histogram derived from the light transmittance image which is inset in FIG. 21 for an oil sample containing more precipitated asphaltene particles than the oil sample of FIG. 20, in which the X-axis represents light transmittance intensity, the Y-axis represents frequency of a particular light transmittance intensity throughout the light transmittance image and the two curves represent modal intensity of liquid and solid phases;

FIG. 22 is a graphical representation of a sequence of light transmittance intensity histograms including those depicted in FIG. 19, FIG. 20 and FIG. 21, in which the X-axis represents pentane solvent ratio, the Y-axis represents light transmittance intensity and the Z-axis represents frequency of a particular light transmittance intensity throughout a light transmittance image;

FIG. 23 is a graphical representation of a sequence of light transmittance intensity histograms derived from light transmittance images for oil samples at a pressure of 22.8 Mpa and at a temperature of 60 degrees Celsius, in which the X-axis represents CO₂ solvent ratio, the Y-axis represents light transmittance intensity and the Z-axis represents frequency of a particular light transmittance intensity throughout a light transmittance image;

FIG. 24 is a graphical representation of a sequence of light transmittance intensity histograms derived from light transmittance images for oil samples at a pressure of 22.8 Mpa and at a temperature of 60 degrees Celsius, in which the X-axis represents CO₂ solvent ratio, the Y-axis represents light transmittance intensity and the Z-axis represents the product of light transmittance intensity and frequency of the light transmittance intensity throughout a light transmittance image;

FIG. 25 is a graphical representation of a sequence of frequency domain power spectra derived from oil sample data obtained using a test spectrophotometer apparatus of the type shown in FIG. 2 for oil samples at a pressure of 22.8 Mpa and at a temperature of 60 degrees Celsius, in which the X-axis represents CO₂ solvent ratio, the Y-axis represents temporal frequency and the Z-axis represents power;

FIG. 26 is a graphical representation of a system pressure signal pertaining to the system pressure within the test spectrophotometer apparatus during the gathering of the oil sample data of FIG. 23, FIG. 24 and FIG. 25, in which the X-axis represents time and the Y-axis represents system pressure;

FIG. 27 is a graphical representation of a sequence of characterization numbers calculated from the power spectra depicted in FIG. 25, in which the X-axis represents CO₂ solvent ratio and the Y-axis represents characterization number;

FIG. 28 is a modified version of a segment of the graphical representation of FIG. 27 which has been prepared using a multiple Gaussian function solved using non-linear least squares in which the X-axis represents CO₂ solvent ratio and the Y-axis represents characterization number;

FIG. 29 is a contour graph depicting the onset of precipitation of asphaltene particles in oil samples for a range of CO₂ solvent concentrations, in which the X-axis represents temperature, the Y-axis represents pressure and each curve represents a particular CO₂ solvent concentration expressed in moles per litre,

FIG. 30 is a contour graph depicting the onset of the second liquid phase for oil samples having a range of CO₂ solvent concentrations, in which the X-axis represents temperature, the Y-axis represents pressure and each curve represents a particular CO₂ solvent concentration expressed in moles per litre;

FIG. 31 is a graphical representation of the contour graph of FIG. 29 in which the X-axis represents temperature, the Y-axis represents pressure and the Z-axis represents CO₂ solvent concentration expressed in moles per litre;

FIG. 32 is a graphical representation of the contour graph of FIG. 30 in which the X-axis represents temperature, the Y-axis represents pressure and the Z-axis represents CO₂ solvent concentration expressed in moles per litre;

FIG. 33 is a graphical representation of a typical system pressure signal depicting fluctuations in system pressure within a test apparatus of the type shown in FIG. 1 for oil samples having a particular solvent ratio, in which the X-axis represents time and the Y-axis represents system pressure;

FIG. 34 is a graphical representation of a typical sequence of frequency domain power spectra derived from a series of system pressure signals obtained from oil samples having varying solvent ratios, in which the X-axis represents solvent ratio, the Y-axis represents temporal frequency and the Z-axis represents power;

FIG. 35 is a graphical representation of a sequence of characterization numbers calculated from the sequence of power spectra depicted in FIG. 34 in which the X-axis represents CO₂ solvent ratio and the Y-axis represents characterization number based upon system pressure signals, together with an overlay curve in which the X-axis represents CO₂ solvent ratio and the Y-axis represents characterization number based upon light transmittance signals;

FIG. 36 is a representative set of sixteen light transmittance images obtained using a microscope and video camera depicting a water in oil emulsion as the dispersed phase coalesces over time;

FIG. 37 is a representative set of four two dimensional frequency domain power spectra derived from light transmittance images of the type depicted in FIG. 36;

FIG. 38 is a representative set of four two dimensional frequency domain power spectra derived from light transmittance images of the type depicted in FIG. 36;

FIG. 39 is a graphical representation of a sequence of characterization numbers calculated from two dimensional power spectra such as those depicted in FIG. 37 and FIG. 38, in which the X-axis represents time and the Y-axis represents characterization number;

FIG. 40 is a view of derivative images of the sixteen light transmittance images depicted in FIG. 36 in which the derivatives of the light transmittance images have been taken along the X-axis in order to reduce the DC component in the light transmittance images;

FIG. 41 is a graphical representation of four composite one dimensional frequency domain power spectra derived from derivatives of four light transmittance images of the type depicted in FIG. 40, in which each of the four composite one dimensional frequency domain power spectra has been derived from a series of sample lines taken along the X-axis of the derivative of the light transmittance image to produce a composite power spectra which includes light transmittance data from each of the sample lines, in which the X-axis represents spatial frequency and brightness represents power;

FIG. 42 is a graphical representation of four composite one dimensional frequency domain power spectra derived from derivatives of four light transmittance images of the type depicted in FIG. 40, in which each of the four composite one dimensional frequency domain power spectra has been derived from a series of sample lines taken along the X-axis of the derivative of the light transmittance image to produce a composite power spectra which includes light transmittance data from each of the sample lines, in which the X-axis represents spatial frequency and brightness represents power;

FIG. 43 is a graphical representation of a typical sequence of one dimensional frequency domain power spectra of the type depicted in FIG. 41 and FIG. 42, in which the X axis represents time, the Y-axis represents spatial frequency and the Z-axis represents average power derived from a series of sample lines at a particular time and spatial frequency.

### DETAILED DESCRIPTION

In a first preferred embodiment, the invention is directed a method for analyzing or characterizing a dispersion comprising an oil mixed with a solvent. In particular, in the first preferred embodiment the invention is directed specifically at characterizing the dispersion with respect to the stages of separation of asphaltene particles which are contained in a crude oil.

Precipitation is the first separation stage in which asphaltene particles form as a distinct phase as they come out of solution. The second separation stage is the flocculation or agglomeration stage in which the small asphaltene particles clump together and grow larger. The third separation stage is deposition, which is the point at which the asphaltene particles are so large that they can no longer be supported by the liquid and therefore they settle out on solid surfaces. Finally, a fourth stage may be the formation of a second dense liquid phase which is rich in solvent as the solvent reaches a saturation concentration in the oil.

As discussed previously, the use of miscible solvents, such as ethane, propane, butane, pentane or CO₂, in IOR processes requires knowledge of how the solvent will behave over all mixing ratios of oil and solvent. In particular it is important to know: (i) at what solvent concentration the asphaltenes start to precipitate; and (ii) what conditions will cause the particles to agglomerate and eventually deposit in the reservoir pore network. Thus, as indicated, the present invention is directed in part at a method of describing or characterizing the process of asphaltene precipitation/agglomeration/deposition under typical reservoir conditions.

The first preferred embodiment of the within method is described herein with respect to the application of the method for the analysis and characterization of a dispersion, particularly a liquid-solid suspension. More particularly, the preferred embodiment of the within method is described with respect to its application for the analysis of a dispersion comprised of an oil.

More particularly, in the first preferred embodiment the dispersion is comprised of oil. The oil may be comprised of any oil in which solid particles may be suspended or become suspended, including light to heavy crude oils. The solid particles which are suspended or become suspended in the oil may include organic materials such as asphaltene particles or inorganic materials such as sand particles.

Further, the oil may be mixed with a solvent and the solvent may stimulate the precipitation of solid particles such as asphaltene particles from the oil. Although the oil may be mixed with any solvent, such as those typically used in IOR processes to enhance the oil recovery or production process, the solvent described in the preferred embodiment herein is comprised of either pentane or CO₂.

More specifically, in the first preferred embodiment the oil is comprised of a crude oil and the solid particles of interest are comprised of asphaltene particles, the precipitation of which is stimulated by the mixing of a solvent with the crude oil.

The analysis or characterization method may be used to provide information relating to the conditions under which the particles within the dispersion will tend to precipitate, agglomerate and deposit. Specifically, the method may be used to obtain from a set of data information relating to the onset of precipitation, agglomeration and deposition of the asphaltenes at varying pressure and/or temperature conditions and at varying concentrations or ratios of the solvent mixed with the oil. Further, the effect of each of these variables may be determined or analyzed over a period of time.

However, the method described herein is more generally applicable to the analysis and characterization of any dispersion, as defined previously. Thus, the within method is also applicable to emulsions or other types of dispersions.

In particular, the method has been applied in a second preferred embodiment to the analysis or characterization of a dispersion comprised of an emulsion, wherein the emulsion is comprised of oil and water. In this case, the results of the analysis or performance of the method may be used to provide information relating to the conditions under which the emulsion will tend to stabilize or destabilize, depending upon the desired result. Specifically, the method may provide information relating to the coalescing and separation of the liquid components of the emulsion at varying pressure and/or temperature conditions and at varying concentrations, ratios or relative amounts of the liquid components within the emulsion. Further, as stated previously, the effect of each of these variables may be determined over a period of time.

In addition, in the first preferred embodiment, along with the deposition of the asphaltenes, the solvent and other liquid components of the oil will may exhibit a second liquid phase. The within method may further be used to analyze or characterize the dispersion in the presence of this second liquid phase. The results of the analysis or performance of the method may be used to provide information relating to the stability or miscibility of the second liquid phase under varying conditions, such as varying pressure and/or temperature conditions, and at varying concentrations, ratios or relative amounts of the solvent in the second liquid phase. Once again, the effect of each of these variables may be determined over a period of time.

In all of the preferred embodiments of the invention, the method involves the collection of a set of original domain data relating to an attribute of the dispersion. The set of original domain data may relate to any attribute of the dispersion. For instance, the original domain data may relate to the pressure of the dispersion. In this case, the pressure of the dispersion may be collected or measured by any pressure transducer or sensor capable of measuring or sensing the pressure of the dispersion. However, in the first preferred embodiment, the original domain data relates to light transmittance or transmittance of electromagnetic radiation through the dispersion.

In all of the preferred embodiments, the set of original domain data is transformed into a transformed set of original domain data, wherein the transformed set of original domain data is in the frequency domain. Finally, in all of the preferred embodiments the dispersion is characterized using the transformed set of original domain data.

The transformation of the original domain data to the frequency domain may be performed using any applicable or suitable transformation technique or method. For instance, the transformation may be performed using one or more of the following methods: Fourier transform (FT) method; fast Fourier transform AFT) method; maximum entropy method; free cosine transform method; discrete cosine transform method; and wavelet analysis method. In the preferred embodiments, the transformation is performed using either the fast Fourier transform (FFT) method or the maximum entropy method.

Further, the method preferably includes the step of generating a frequency domain spectrum from the transformed set of original domain data. The frequency domain spectrum expresses a parameter relating to the attribute of the dispersion as a function of frequency.

In the first preferred embodiment, the parameter provides a measure relating to the transmittance of electromagnetic radiation through the dispersion. Although any parameter or measure may be used, in the preferred embodiment, the parameter is power such that the frequency domain spectrum is comprised of a power spectrum expressing power as it relates to electromagnetic radiation transmittance as a function of frequency. Thus, the characterizing step is performed using the frequency domain spectrum, or the power spectrum in the preferred embodiment.

As well, the set of original domain data preferably relates to the amount of light transmittance through the dispersion over a period of time or over a spatial area. In other words, the transformation of the set of original domain data is preferably from either the time domain or the space domain to the frequency domain.

For example, the set of original domain data may be comprised of a transmittance signal representing transmittance of electromagnetic radiation through the dispersion over a period of time. In this case, the method preferably includes manipulating the dispersion during the period of time in order to cause variation in the transmittance signal over the period of time. Alternatively, the set of original domain data may be comprised of an image representing distribution of transmittance of electromagnetic radiation through the dispersion over a spatial area.

Further, in the first preferred embodiment, the collecting step is comprised of collecting a plurality of subsets of original domain data so that the set of original domain data is comprised of the subsets of original domain data The transforming step is therefore preferably comprised of transforming the subsets of original domain data into a plurality of subsets of transformed original domain data The step of generating a frequency domain spectrum is preferably similarly comprised of generating a frequency domain spectrum from each of the subsets of transformed original domain data in order to produce a plurality of frequency domain spectra. Finally, the characterizing step is performed using the subsets of transformed original domain data and preferably, using the frequency domain spectra.

In addition, preferably the collecting step is comprised of collecting each of the subsets of original domain data at a different value of a dispersion characterizing variable so that the dispersion may be characterized with respect to the dispersion characterizing variable.

In the first preferred embodiment in which the dispersion is comprised of oil such as crude oil, the dispersion characterizing variable may be an amount of solvent mixed with the oil or the solvent/oil ratio. Alternatively, in a preferred embodiment where the dispersion is comprised of an emulsion comprising oil and water, the dispersion characterizing variable may be time or a ratio of the relative amounts of oil and water contained in the emulsion.

Thus, where each of the subsets of original domain data is collected at a different value of the dispersion characterizing variable, such as the solvent/oil ratio, the dispersion may be characterized with respect to that dispersion characterizing variable. Accordingly, the characterizing step may be comprised of generating from the frequency domain spectra an expression of the parameter, such as power, relating to the attribute of the dispersion as a function of both frequency and the dispersion characterizing variable in order to characterize the dispersion with respect to the dispersion characterizing variable.

Different equipment or processes may be used to collect the original domain data depending upon the attribute of the dispersion to which the original domain data relates and whether the original domain data is desired to be in the time domain or the spatial domain.

For example, spectrophotometric methods are preferably used to collect original domain data relating to the amount of light transmittance through the dispersion over a period of time. Specifically, the amount of light transmittance through the dispersion is measured or recorded as the dispersion flows through or moves past the spectrophotometer. Measurements of the light transmittance of a non-homogeneous fluid as it moves past a light source are often referred to as “time of flight” measurements. A micro visual cell is preferably used to collect original domain data relating to the amount of light transmittance through the dispersion over a spatial area at a point in time.

Although the concept of spectrophotometric methods as a tool to study precipitation has been previously described (Jamaluddin, A. K. M. et. al., “Laboratory Techniques to Measure Thermodynamic Asphaltene Instability”, JCPT, Jul. 2002, Vol. 41), the use of the time to frequency conversion in “time of flight” measurements to obtain a much richer range of information from has not been reported in such experiments. The time domain to frequency domain conversion or transformation provided by the within invention gives more detailed information about the changes in particle size, as the solvent/oil ratio changes. This class of information has been found to be very sensitive to changes in the distributions found in the flow stream, and as such may be of great use in studying the flocculation or agglomeration process as a time dependent variable.

A somewhat less common method which has been previously described as a tool to study precipitation is the use of the micro visual cell to acquire images as the solvent/oil ratio changes (Jamaluddin, A. K. M. et. al., “Laboratory Techniques to Measure Thermodynamic Asphaltene Instability”, JCPT, Jul. 2002, Vol. 41). These images contain information about the total light transmitted Oust as the spectrophotometer does) and the fraction of the cell area occupied by the solid particles.

If the image is sampled properly, the method of the within invention may be used to convert or transform the spatial information contained in the image with respect to the solid particles into frequency domain information in the same fashion as the spectrophotometric time/frequency transformation. Depending upon the specific methodology used, the net result of this transformation may either be a one dimensional frequency domain transform or a two dimensional frequency domain transform, either of which will provide detailed information about the changes in particle size in space and time. These frequency domain transforms may be presented in varying formats as discussed below.

For instance, the method may use image analysis to convert or transform the information obtained from a typical sequence of images obtained from a dynamic high pressure mixing system acquired using a micro visual cell and special optics. These images may be analyzed and a single number per image computed. As described in further detail below, this number is referred to as the “characterization number”, although it may also be referred to as the “particle characterization number” (PCN) or the “particle growth factor” (PGF) depending upon the nature of the dispersion and the characterization which is being performed.

The characterization number is a compound number that includes information about the size of the particles, the number of particles and their shape. Specifically, the characterization number involves the size of all particles, the number of particles and the nature of the edges of all particles. It has been found that the characterization number is directly proportional to the growth of asphaltene particles and thus, the characterization number has been shown to be a useful tool in the characterization of an oil suspension as in the first preferred embodiment.

The method of the present invention shows how the characterization number tends to increase with respect to solvent concentration. If a suitable non-linear model is used to fit characterization number with respect to concentration, the characteristics of the function may be used to predict the onset of precipitation, the point of maximum agglomeration or flocculation, and when deposition is at its maximum. A representation of the data may then be produced using curve fitting techniques such as a least squares correlation which relates the concentration of asphaltene precipitation onset to both pressure and temperature using a 3D polynomial surface.

As stated, the frequency domain spectrum provided by the transformation into the frequency domain from the time or spatial domain may be presented in a number of different formats. The particular format utilized is dependent, at least in part, upon whether a one dimensional transform or a two dimensional transform is performed. Specifically, the transforming step may be comprised of either transforming the set of original domain data in one dimension, which may be referred to as a “one dimensional transform,” or transforming the set of original domain data in two dimensions, which may be referred to as a “two dimensional transform.”

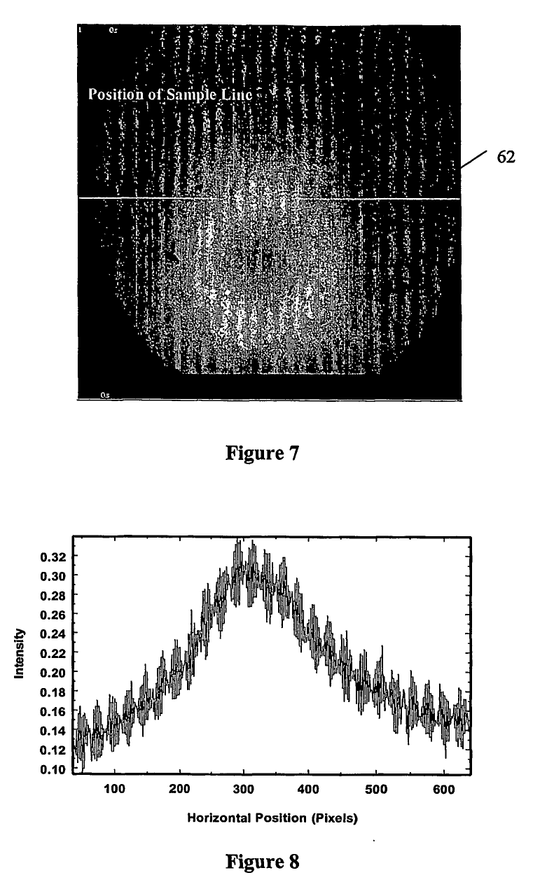

A one dimensional transform involves the transformation of the set of original domain data in one dimension along at least one sample line, such as along a horizontal slice of the data, as shown in FIG. 7. However, if desired, the transforming step may be comprised of transforming the set of original domain data in one dimension along a plurality of sample lines. Thus, a plurality of one dimensional transforms may be performed. In this instance, the step of generating the frequency domain spectrum from the transformed set of original domain data is preferably comprised of determining from the plurality of sample lines an average value for the parameter relating to the attribute of the dispersion, preferably light transmittance, as a function of frequency. A two dimensional transform involves a transformation of the set of original domain data in two dimensions. Thus, all of the sample data, for example all of the data within the image taken by the micro visual cell, is transformed.

For a one dimensional transform, each frequency domain or power spectra for each sample line may be presented as a 1-dimensional graph (1D graph). The various 1D graphs may then be combined to produce a 2-dimensional graph (2D graph) of the frequency domain spectrum, preferably a power spectrum. Alternatively, where a one dimensional transform is performed along a plurality of sample lines, a representative value such as an average value for the parameter relating to the attribute of the dispersion, preferably power may be utilized to create a 2D graph.

Alternatively, as discussed above, the characterization number may be used in the presentation of the frequency domain spectrum. In this instance, the method may include the step of integrating each of the frequency domain spectra between an upper selected frequency and a lower selected frequency, thereby obtaining a characterization number for each of the frequency domain spectra. Further, an expression of characterization number as a function of the dispersion characterizing variable may be generated from the characterization numbers in order to characterize the dispersion with respect to the dispersion characterizing variable, as discussed above.

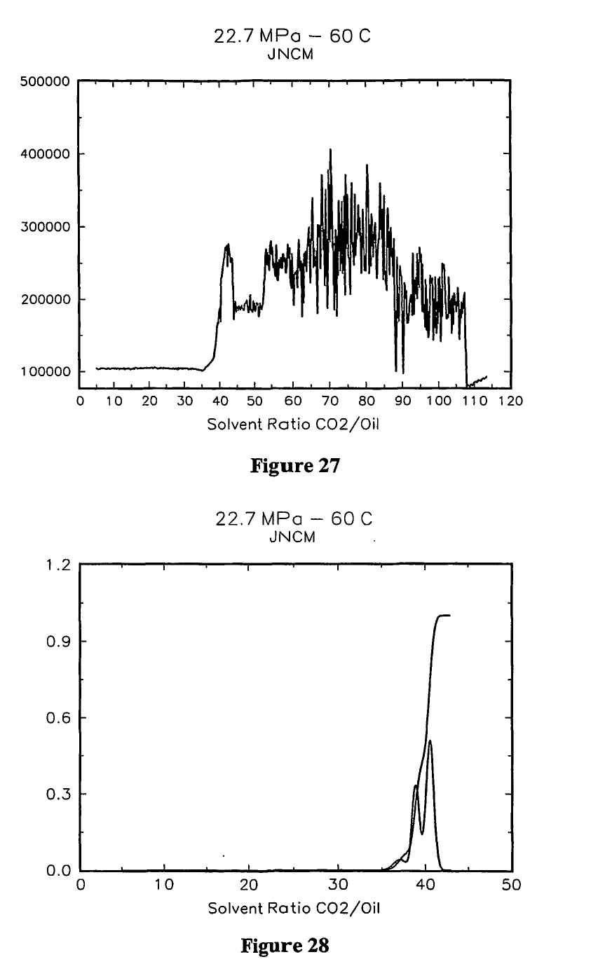

Accordingly, with respect to a one dimensional transform, the characterization number for each frequency domain spectra provides an expression of the area between the upper and lower selected frequencies for the frequency domain spectra. With respect to a two dimensional transform, the characterization number for each frequency domain spectra provides an expression of the volume between the upper and lower selected frequencies for the frequency domain spectra The characterization numbers for the frequency domain spectrum may then be plotted on a characterization number curve as a function of the dispersion characterizing variable, such as the solvent/oil ratio of the dispersion, to create a 1D graph as shown in FIG. 27. Finally, where desired, the characterization number curve may be normalized to fit a normal distribution using known statistical techniques, such as a multi-Gaussian function, as shown in FIG. 28.

Finally, the derivative of the characterization number curve may be computed to provide further information from which to characterize the dispersion. Specifically, in the within method, the characterizing step may be further comprised of calculating a derivative of the expression of characterization number as a function of the dispersion characterizing variable to obtain a characterization number gradient curve in order to further characterize the dispersion with respect to the dispersion characterizing variable.

As described further below, various studies have been conducted to show the application of the within method. For instance, in one study frequency domain imaging was applied to analyze or characterize the asphaltene precipitation/agglomeration/deposition process for a CO₂ miscible flood. The objectives of this study included: the determination of the onset of asphaltene precipitation, agglomeration and deposition outside porous media (bulk flow); the assessment of CO₂ miscibility in the region around 20 MPa (2900 psi); the investigation of the possible appearance of a second liquid phase; and the development of the within method to enhance the ability to determine the maximum amount of information from the dynamic mixing of solvent and oil, and do this in a relatively fast and efficient manner.

More particularly, this study was aimed at the investigation of the changes in asphaltene particle size as the solvent/oil ratio changed during bulk oil-CO₂ mixture flow. The oil/solvent system was first tested with pentane as the solvent, for a first set of validation experiments, since pentane is a well-known solvent for the precipitation of asphaltenes. These measurements helped provide a baseline case to better understand the behavior of the oil with CO₂ as a solvent.

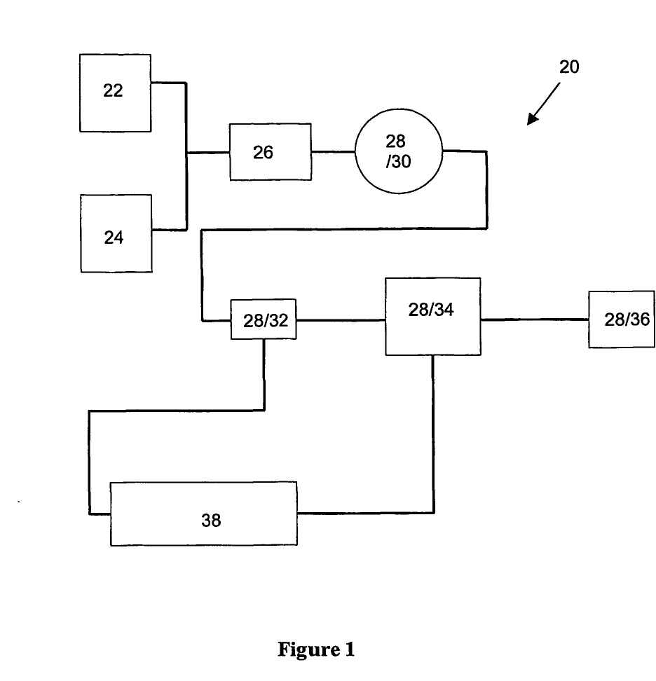

A schematic of a preferred data collection system (20) used in the performance of the first preferred embodiment of the method, and particularly used to conduct the studies relating to the analysis of the precipitation, agglomeration and deposition of asphaltenes contained in oil samples as a function of concentration of the solvent, is shown in FIG. 1. The valves, bypass loops, transfer vessels and heating systems, needed for operational systems are not shown.

Referring to FIG. 1, the data collection system (20) is comprised of a first pump (22) for injecting oil into the data collection system (20) and a second pump (24) for injecting a solvent into the data collection system (20). Thus, the first and second pumps (22, 24) are used to control the solvent/oil ratio within the data collection system (20). More particularly, the data collection system (20) is preferably comprised of a dual piston pump system which allows the flow ratio of the solvent to oil to be changed or varied in a relatively fast, precise manner. Further, the first and second pumps (22, 24) co-inject the oil and solvent at the system pressure into a static mixer (26).

In addition, the data collection system (20) is comprised of at least one data collection apparatus (28) for collecting the original domain data relating to a selected attribute of the dispersion. Preferably, the data collection system (20) is comprised of a plurality of data collection apparatuses (28) to permit the concurrent collection of original domain data relating to one or more attributes of the dispersion.

For instance, referring to FIG. 1, the data collection system (20) is comprised of four data collection apparatuses (28) including: a micro visual cell apparatus (30) to provide original domain data relating to the transmittance of electromagnetic radiation through the dispersion over a spatial area; a spectrophotometer (32) to provide original domain data relating to the transmittance of electromagnetic radiation through the dispersion over a period of time; a viscometer (34), such as a capillary viscometer, to provide original domain data relating to the viscosity of the dispersion over a period of time; and a pressure sensor or transducer (36) to provide original domain data relating to the pressure of the dispersion over a period of time.

Further, a data acquisition device (38) may be associated with one or more of the data collection apparatuses (28) for collecting and storing the original domain data provided thereby. Referring to FIG. 1, the data acquisition device (38) is associated with the spectrophotometer (32) and the viscometer (34).

In the first preferred embodiment, the within method may be conducted using either the micro visual cell apparatus (30) or the spectrophotometer (32) for the collection of the original domain data relating to the transmittance of light through the dispersion. Alternatively, as shown by the data collection system (20) of FIG. 1, in the preferred embodiment, the original domain data is concurrently collected by both the micro visual cell apparatus (30) and the spectrophotometer (32).

It has been found that the frequency domain spectrum or power spectrum produced by the transformation of the spatial domain and time domain data from the micro visual cell apparatus (30) and the spectrophotometer (32) respectively is in many circumstances substantially consistent. Therefore, the use of both the micro visual cell apparatus (30) and the spectrophotometer (32) allows for a check of the accuracy of the frequency domain spectra produced from the original domain data.

As stated, in the first preferred embodiment the original domain data relates to an attribute of the dispersion, preferably light transmittance through the dispersion. However, as indicated above, the attribute may be viscosity of the dispersion and the viscometer (34) may be used to collect original domain data relating to viscosity transients experienced by the dispersion. Thus, the viscometer (34) may be used to collect original domain data instead of, or in addition to, the micro visual cell apparatus (30) or the spectrophotometer (32).

Similarly, the attribute may be pressure of the dispersion and the pressure transducer (36) may be used to collect original domain data relating to pressure transients experienced by the dispersion within the data collection system (20). Accordingly, the pressure transducer (36) may also be used to collect original domain data instead of, or in addition to, any or all of the micro visual cell apparatus (30), the spectrophotometer (32) and the viscometer (34). Further, the pressure transducer (36) may be required to measure changes in the effective viscosity of the solvent/oil mixture.

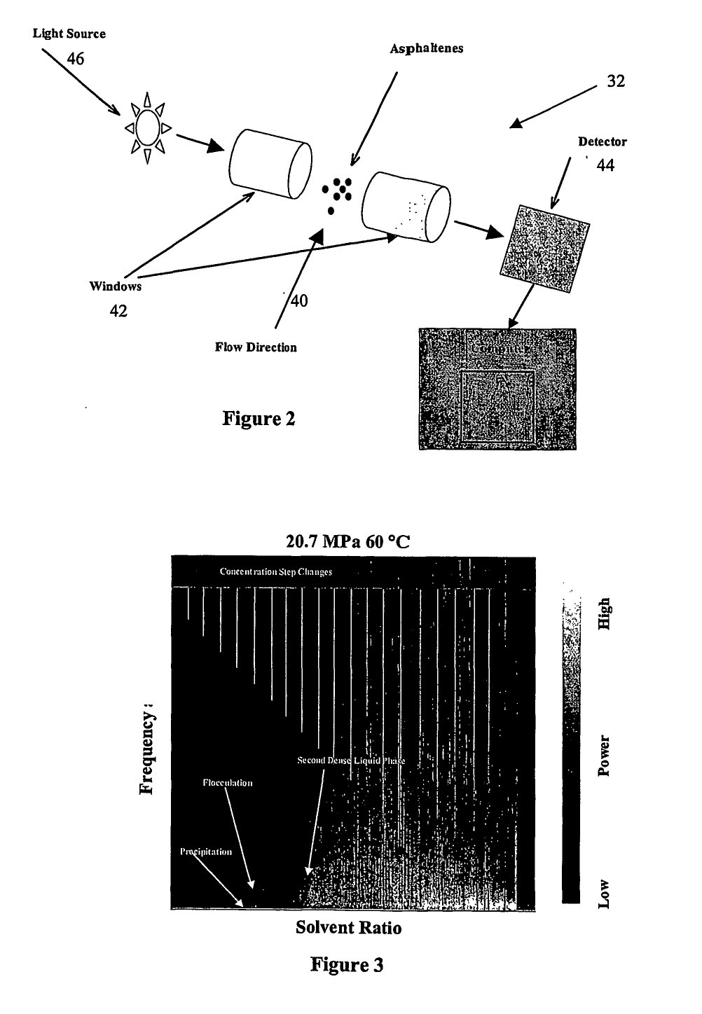

A preferred configuration of the spectrophotometer (32) used to perform the first preferred embodiment of the method and to conduct the studies herein is shown in FIG. 2. The dispersion flows or moves through a conduit, generally indicated by the arrow shown as reference number (40), between opposed windows (42) comprising the spectrophotometer (32). In addition, the spectrophotometer (32) is comprised of a transmittance sensor (44), also referred to herein as the detector, and a source of electromagnetic radiation (46), also referred to herein as the light source. As the dispersion flows or moves through the conduit (40) between the windows (42), the light source (46) directs a high intensity light from one window (42) and through the dispersion towards the opposed window (42). The amount of light transmittance through the dispersion is detected at the opposed window (42) by the transmittance sensor (44) which is adapted for the detection of the desired electromagnetic radiation.

Thus, in the first preferred embodiment, the set of original domain data provided by the spectrophotometer (32) is comprised of a transmittance signal representing transmittance of electromagnetic radiation through the dispersion over a period of time or in the time domain. Further, as indicated, the dispersion is preferably manipulated during the period of time in order to cause variations in the transmittance signal over the period of time. More particularly, when using the spectrophotometer (32), the dispersion is manipulated by moving the dispersion and the transmittance sensor (44) relative to each other, and more specifically, moving the dispersion through the conduit (40) past the transmittance sensor (44). In the preferred embodiment using the spectrophotometer (32) described herein, the dispersion is manipulated by moving the dispersion through the conduit (40) between the source of electromagnetic radiation (46) and the transmittance sensor (44).

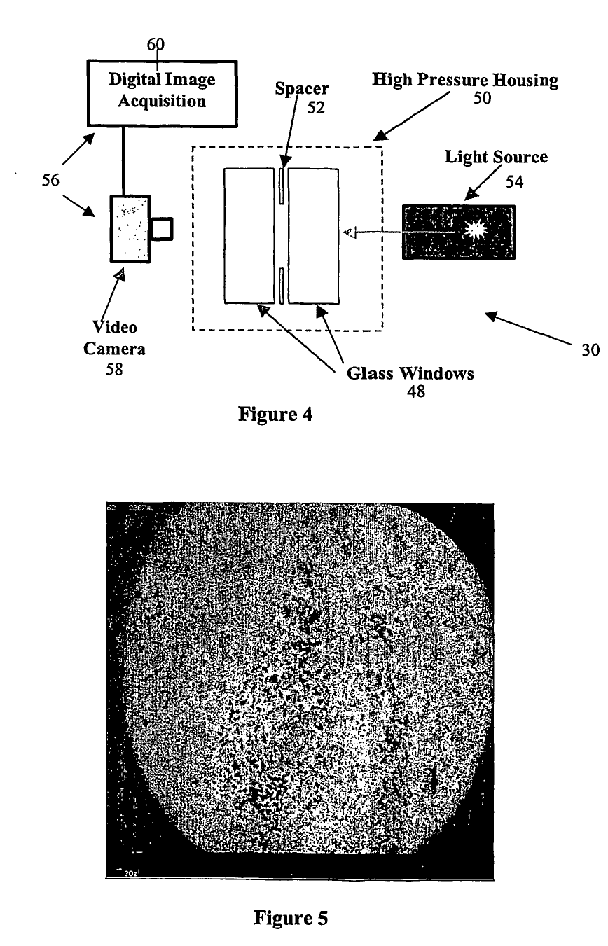

A preferred configuration of the micro visual cell apparatus (30) used to perform the first preferred embodiment of the method and to conduct the studies herein is shown in FIG. 4. Once again, the dispersion flows or moves between opposed windows (48) contained within a housing (50), preferably a high pressure housing, comprising the micro visual cell apparatus (30). In addition, the micro visual cell apparatus (30) is comprised of a spacer (52) positioned between the windows (48) for maintaining a desired spacing or distance therebetween. Further, the micro visual cell apparatus (30) is comprised of a source of electromagnetic radiation (54), also referred to herein as the light source, and a digital acquisition system (56), which may also be referred to herein as the video system. The digital acquisition system (56) is preferably comprised of a video camera (58) and a video digitizer (60).

Thus, as the dispersion flows or moves between the windows (48), the light source (54) directs a high intensity light from one window (48) and through the dispersion towards the opposed window (48). The amount of light transmittance through the dispersion is then captured by the digital acquisition system (56).

In the first preferred embodiment, the micro visual cell apparatus (30) and the spectrophotometer (32) are both preferably adapted to permit or provide for the placement of the opposed windows (48, 42) in close proximity to each other. The minimum inter-window distance for both the micro visual cell apparatus (30) and the spectrophotometer (32) is preferably in the order of about 100 to 200 microns. Small path length optical systems are required when the data collection apparatus (28) is to be used with medium to heavy crude oils, since these oils are very dark and transmit very little light.

In addition, a second issue in the operation of both the micro visual cell apparatus (30) and the spectrophotometer (32) is the need for the light source (54, 46) to be capable of providing a high intensity light. For instance, in the preferred embodiment of the spectrophotometer (32), a non-imaging concentrator is preferably used to direct light from a “300 watt” quartz halogen reflector bulb directly into the window aperture. This method supplies light at intensities much greater than a lens based system.

Further, the light transmittance recorded by the spectrophotometer (32) is preferably recorded in digital form. The digital recording of the light transmittance is conducted or performed by the data acquisition device (38) which is preferably comprised of a computer and an analog to digital converter. Further, the data acquisition device (38) for the spectrophotometer (32) is preferably at least 16 bits in order to achieve the required or desired resolution in the frequency domain.

The power line frequency (50/60 Hz) represents one of several interferences to this class or type of measurement and is therefore preferably kept to a minimum. To achieve this goal, a high voltage DC power supply is utilized to provide power to the light source (46). Further, in order to facilitate the time of flight studies of particle size, the computer preferably digitizes the photometric information at sample rates in the order of 256 Hz, or higher.

The micro visual cell apparatus (30) is preferably monitored using the video camera (58) and the video digitizer (60), preferably at least a 10 bit video digitizer, associated with a computer. The video digitizer (60) allows the capture of 10 bit images which provides a relatively high quality of image data as a result of improved resolution. The measurement of the oil/solvent dispersion involves the use of Beer's law to interpret the changes in solvent/oil interactions. Thus, for example, in contrast with an 8 bit image, by dividing the percentage transmission information for each pixel by 1023 (for a 10 bit image) as opposed to 255 (for an 8 bit image), the amount of resolution obtained from the image is enhanced by a factor of about 4.

The computer software for the micro visual cell apparatus (30) preferably permits or provides for the user to acquire images at variable rates, and to store the image files on the computer in a format that allows the time at which the image was captured to be stored in the image header. In order to achieve this goal, an image file format is utilized that stores the capture time and other information in each image file. Preferably, the images are acquired at least every 16 seconds over the range of solvent to oil ratios needed for a particular study.

In the studies conducted with respect to the first preferred embodiment of the method, the solvent/oil ratio was controlled by using two pumps (22, 24), preferably a dual piston pump system as described above, which co-inject both oil and solvent into the static mixer (26), at a system pressure. The total flow rate is preferably kept to 1000 micro litres a minute, with flow ratio changes in steps of 50 to 100 μl/min for approximately 7 min per step. This results in an approximation of almost continuous concentration change at the transmittance sensor (44) of the spectrophotometer (32) with respect to time. In the first study described herein relating to the first preferred embodiment, this rate of concentration change was 50 μl/min steps in 5.0 min increments. Ideally, however, the solvent/oil ratio would change as constantly as possible over time rather than in steps or discrete increments in order to approximate continuous concentration change over time as closely as possible.

In addition, if desired, the pressure of the dispersion may also be studied using one or more pressure transducers (36) as discussed above. Preferably, one or more 10,000 psi absolute pressure transducers (36) are used to monitor the dispersion pressure at the entry or injection end of the data collection system (20). The results of the information provided by the transducers (36) is preferably provided as pressure with respect to time plots. Similarly, if desired, the viscometer (34) may be used to provide information relating to changes in viscosity of the oil/solvent dispersion.

As discussed above, FIG. 2 is a schematic drawing showing the elements of the “Time of Flight” particle size characterization method, where the windows (42) represent a high-pressure spectrophotometric conduit (40) or cuvette.

The basic principle involved is that as a particle flows through the light path it changes the amount of light measured at the transmittance sensor or detector (44) in two ways. First, the size of the particle decreases the amount of transmitted light; second, the time that a particle takes to transit the window (42) affects the size of the depression in light transmittance.

If these two effects are coupled and the transmittance signal is monitored with respect to time (at a high sample rate), the resulting original domain data set may be converted from the time domain into the frequency domain by using the fast Fourier transform (FFT) or related methods. Although any sufficiently high sample rate may be used, the sample rate is preferably at least about 256 Hz in order to improve the resolution of the FFT conversion. In order to transform the transmittance signal from the time domain to the frequency domain, a one dimensional transform is performed.

Referring to FIG. 3, the transformed set of original domain data, provided by a one dimensional transform in this case, may be displayed as a 2D image or a 2D graph where the frequency is on one axis and solvent volume fraction on the other (time and volume fraction are directly related to each other), with the power density as the intensity of the pixels in the transmittance signal.

The terms frequency and power as used herein are defined in a particular manner with respect to the within method. For instance, with respect to the spectrophotometer (32) original domain data, a transmittance signal is collected with respect to time, therefore the frequency is in reciprocal seconds or Hertz. The power in this case is defined by the distribution of transmitted light energy at a given frequency. Since this variation is being measured through a transducer, this connection is uncalibrated and expressed in relative terms, i.e., it is not normalized.

With calibration using standard particles at a constant flow rate, such a signal gives detailed information about the particle size in the flow stream in real time. If the flow rate is not constant then calibration is not possible, but the measurement still retains useful information about the dynamic changes in the distribution of solid particles, assuming that the changes in flow rate are not too large.

Further, as discussed above, the diagram shown in FIG. 4 represents a schematic drawing of the preferred micro-visual cell apparatus (30) for use in the first preferred embodiment of the method, and as used to conduct the first study described herein. FIG. 5 shows a typical transmittance image acquired using the micro-visual cell apparatus (30) of FIG. 4 when a large number of asphaltene particles are present in the oil sample.

A first step in manipulating the transmittance image is preferably to determine the range of intensity in the transmittance image using a histogram of the intensity of every pixel in the image. The range of intensities that can be represented by the video system or digital acquisition system (56) is expressed in terms of the number of bits the video digitizer (60) uses. Preferably, the range of values is from 0 to 255 for 8 bits, and 0 to 1023 for 10 bits. This is a relatively narrow range compared to normal data acquisition systems for voltages and temperatures, which generally use 12 bits or 16 bits. Although 8 bits is not as good as 10 bits, and therefore is less preferred, useful information may be extracted from both systems. However, when dealing with heavy oils, a 10 bit system is typically required (heavy oil systems in the order of 50,000 cp have been measured). This means that the total range of intensity for the dispersions must fall in this range for 100% oil (close to zero transmittance) to 100% solvent (100% transmittance).

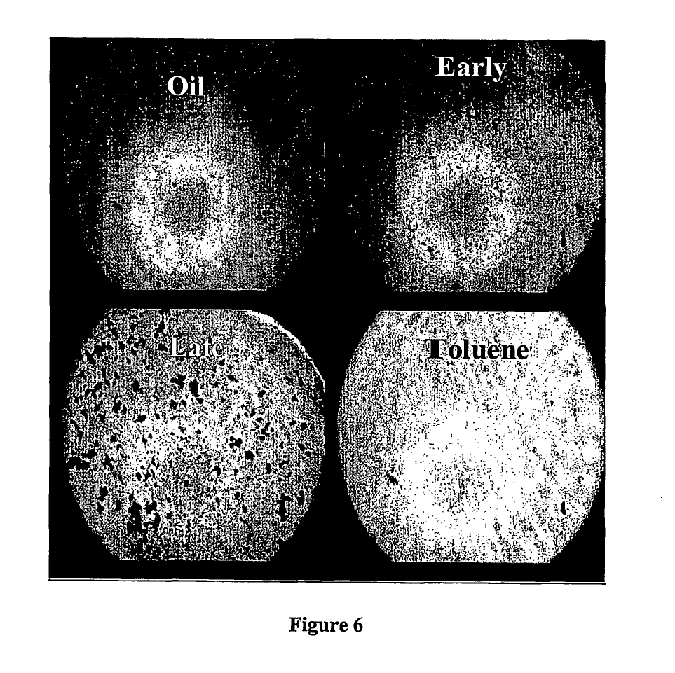

FIG. 6 shows a set of images optimized to cover the whole range while not clipping the minimum or maximum intensity for any pixel in the area of interest (i.e. the window area). More particularly, FIG. 6 shows a set of four typical light transmittance images which have been obtained using the preferred micro visual cell apparatus (30) of FIG. 4. The four images depict oil samples containing different amounts of a solvent, particularly a pentane solvent, in which the light transmittance intensity range has been optimized for each of the images.

In order to study the changes in images over the whole concentration range, the first image may need to be subtracted from all of the other images in the sequence. This results in images with negative pixel values in some of the steps. The need for negative numbers means that an unsigned integer representation cannot be used during processing. The solution to this is to use floating point numbers at this point, and finally convert the results to 8 bit images for presentation. Other calculations as described herein may similarly require the use of floating point numbers.

A typical image sequence may be further manipulated to stretch the dynamic range of the image so that the particles that appear black (low light intensity) will have the maximum contrast between them and the surrounding solvent/oil dispersion. This is achieved by computing the histogram for each image, and then converting it to its cumulative form by integration.

This cumulative curve may then be normalized, and the intensities associated with the 0.1% and 99.9% points are found. With the knowledge of these intensities, all pixels above or below these thresholds are set to these values and the resulting image is renormalized. This typically provides a much more dynamic contrast range for the early precipitation part of the sequence. Alternatively, the cumulative curve may be plotted using logarithmic values for intensity within the image to achieve a similar effect.

The micro visual cell also provides information relating to the size of the particles, but since these particles move from image to image and do not in general produce pixels of zero intensity, the traditional or conventional method of binary segmentation is inappropriate for these transmittance images. However, the method of the within invention permits the extraction of information about changes in size which the particles may be undergoing from image to image.

The extraction of this information is accomplished using a space domain to frequency domain transform method. This transform method involves the concept that in a one dimensional transform case, the variation in the light intensity across the cell can represent the variation in width of objects encountered by a one dimensional transform sample line (62), as shown in FIG. 7. Most of the examples provided herein utilize a similar sample line (62) in performing the one dimensional transform as a result of its relative simplicity as compared with the performance of a two dimensional transform.

However, as noted previously, the transform technique for a transmittance image may use either a one dimensional transform or a two dimensional transform as desired and depending upon the preferred manner of presenting the data. Further, as discussed above, when referring to one dimensional transforms and two dimensional transforms herein, a one dimensional transform represents a one dimensional row or column from the transmittance image (i.e. the sample line), whereas a two dimensional transform represents the transmittance image in two dimensions.

Referring to FIG. 7, a light transmittance image is provided which was obtained using the preferred micro visual cell apparatus (30) described herein and as shown in FIG. 4. The light transmittance image pertains to an oil sample which contains no pentane solvent. Further, FIG. 7 indicates the location of a horizontal slice or one dimensional sample line (62), as discussed above, which extends along the X-axis of the image and which may be utilized in the one dimensional transform.

Again, the terms frequency and power as used herein are defined in a particular manner when used in a discussion of frequency domain analysis for spatially encoded data, such as images obtained by the micro visual cell apparatus (30). Frequency in this context is in reciprocal centimeters (or any other distance unit). The power term is again the variation of light transmittance for each defined spatial frequency.

This representation when applied to image data, gives a distribution of the spatial frequencies found in the image, and the magnitude of power for the variation of transmittance.

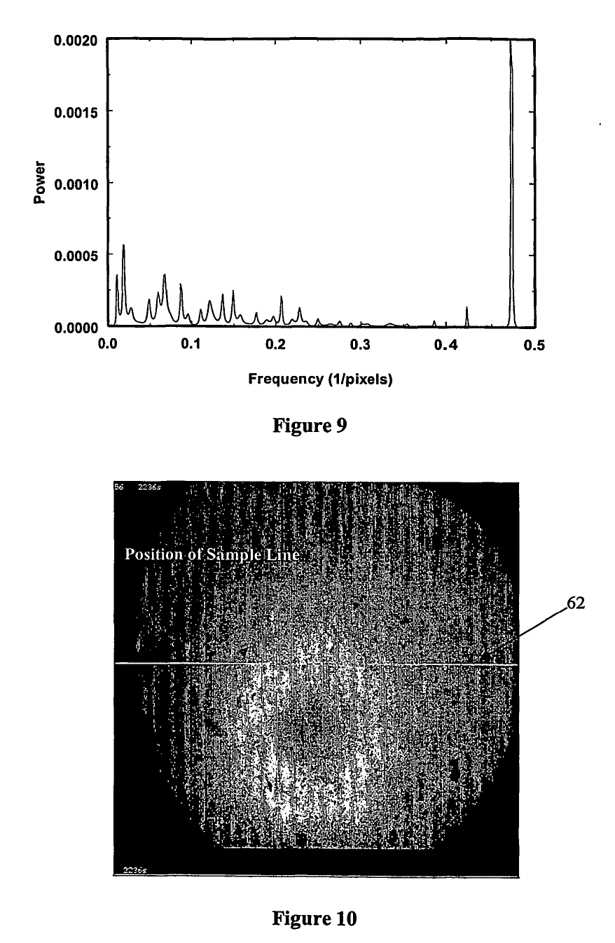

Since the raw image data cannot be defined by any analytical function, the spatial information is converted into the frequency domain using a transforming technique such as the fast Fourier transform (FFT). FIG. 8 is a 1D graph of the data provided by the image shown in FIG. 7. More particularly, FIG. 8 is a graphical representation of a light transmittance signal through the light transmittance image of FIG. 7 along the depicted sample line (62), in which the X-axis represents the horizontal position along the sample line (62) and the Y-axis represents the intensity of light transmittance at a particular horizontal position. Further, FIG. 9 shows a one dimensional transform frequency domain power spectrum derived from the light transmittance signal shown in FIG. 8, in which the X-axis represents spatial frequency and the Y-axis represents power. Referring to FIG. 9, there is noticeable variation in the signal at both the low and high frequency part of the power spectrum.

In this case, the low frequency component is believed to be due to noise or inhomogeneties in the light source (46, 54). Preferably, the set of first domain data obtained by either the spectrophotometer (32) or the micro visual cell apparatus (30) is subjected to a conditioning step by the application of statistical methods to reduce this low frequency component in the frequency domain or power spectrum. In other words, the method preferably includes the step of conditioning the set of original domain data before the transforming step. The conditioning step may also be effective to reduce the DC component in the set of original domain data.

Specifically, the low frequency component and/or the DC component may be reduced or removed by applying one of the locally weighted least squares methods. For instance, the locally weighted average value may be subtracted from each point in the set.

Preferably, with respect to original domain data obtained by the spectrophotometer (32), one of the locally weighted least squares methods is used for the conditioning step, and most preferably the “cubic splines with fixed knots” method is used. Once the low frequency component and/or the DC component have been reduced or removed, the frequency domain or power spectrum may be computed using a suitable transformation method or technique such as the FFT.

Although the same approach may be applied to reduce or remove the influence of the unwanted low frequency component and/or the DC component from the original domain data obtained by the micro visual cell apparatus (30), an alternative data conditioning method is preferred for such data. However, while this alternative data conditioning method is effective for reducing the DC component in the set of original domain data, it is not particularly effective for reducing the low frequency component in the set of original domain data.

Specifically, where a one dimensional transform of the set of original domain data is to be performed, the derivative of each image intensity is taken with respect to distance in the horizontal direction or in the direction of the X-axis. The derivative is then used to compute the frequency domain spectrum in the horizontal direction. This produces an image where the “X” direction is the frequency and wherein frequency relates directly to size. In other words, the conditioning step may be comprised of calculating a derivative of the set of original domain data in one dimension.

Where a two dimensional transform of the set of original domain data is to be performed, the derivative of each image intensity is taken with respect to distance in 2 directions, such as in the direction of both the X-axis and the Y-axis. The derivative in the 2 directions is then used to compute the frequency domain spectrum. A preferred approach is referred to as a “Laplacian Operation.” In other words, the method may be further comprised of calculating a derivative of the set of original domain data in two dimensions before the transforming step in order to reduce the DC component in the set of original domain data.

In any case, once the unwanted DC component is reduced or removed, the preferred transformation method or technique is applied to compute the power spectrum. The FFT method requires that the data set be a power of 2 in size (256, 512 etc). Since this condition cannot always be ensured for 1D samples (i.e. NTSC images of 640×480 aspect ratio), the maximum entropy method is preferably used to compute the power spectra for these samples (being 1D only). The results are shown in FIGS. 9, 12, 15 and 17.

FIGS. 10 through 12 relate to a sample taken where some asphaltene particles are present. Referring to FIG. 10, a light transmittance image is provided which was obtained using a micro visual cell apparatus (30) of the type shown in FIG. 4. The light transmittance image pertains to an oil sample containing a relatively low concentration of pentane solvent. Further, FIG. 10 indicates the location of the 1D sample line (62) extending along the X-axis of the image.

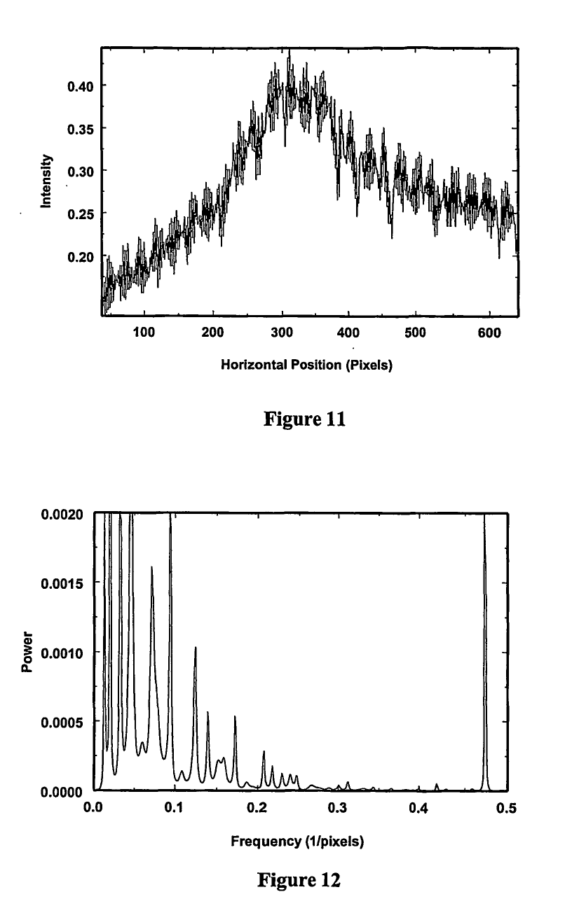

FIG. 11 is a graphical representation of a light transmittance signal through the light transmittance image of FIG. 10 along the depicted sample line (62), in which the X-axis represents the horizontal position along the sample line and the Y-axis represents the intensity of light transmittance at a particular horizontal position. Further, FIG. 12 shows a one dimensional transform frequency domain power spectrum derived from the light transmittance signal shown in FIG. 11, in which the X-axis represents spatial frequency and the Y-axis represents power.

It can be observed that there are small but noticeable drops in the raw 1D signal along the sample line, but that they are not very large in magnitude. The resulting power spectrum in FIG. 12 shows noticeable changes in the distribution of frequencies as compared to FIG. 9, wherein the oil sample of FIG. 12 contains a relatively low concentration of pentane solvent while the oil sample of FIG. 9 contains no pentane solvent.

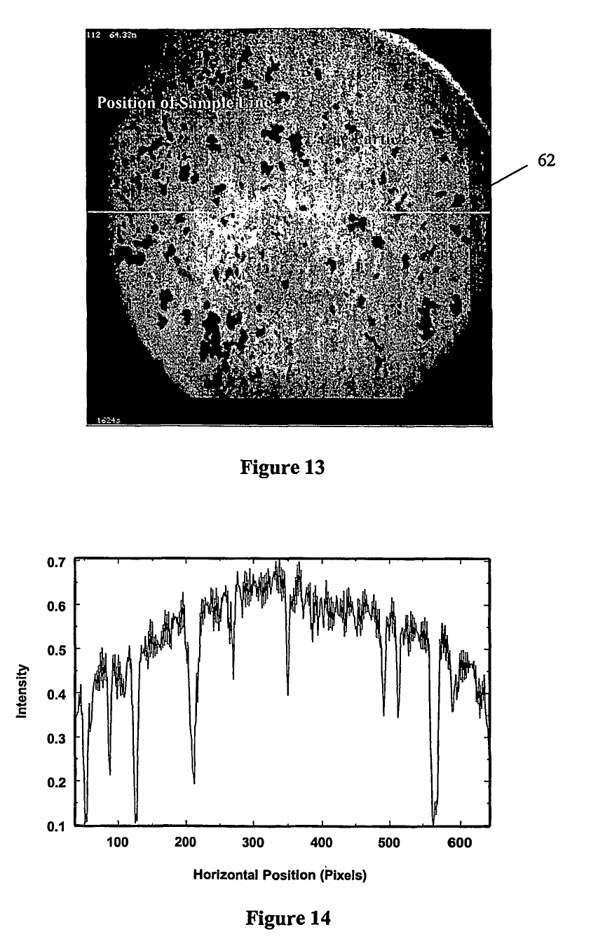

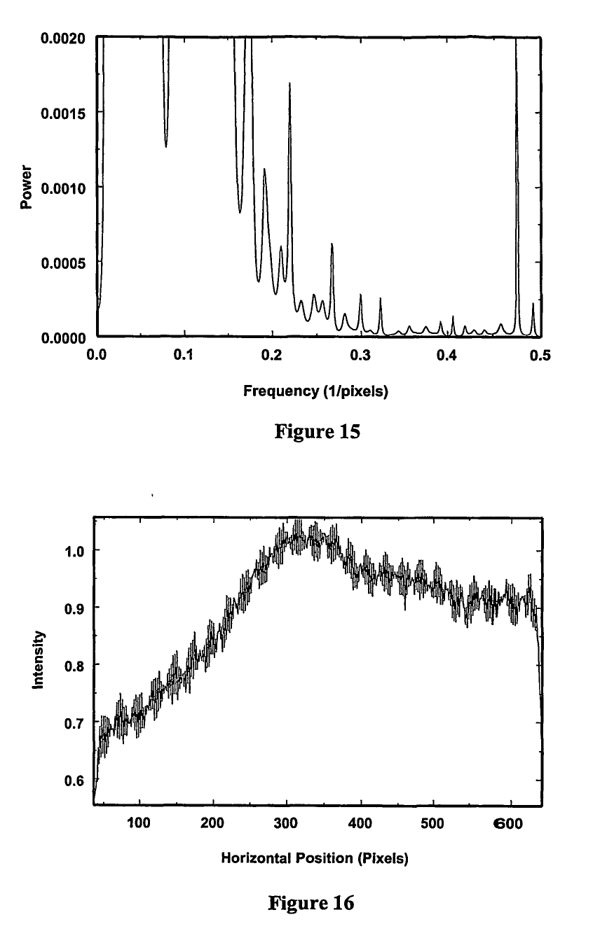

The process is further repeated in FIGS. 13 through 15, wherein the asphaltene particles are both large and very dark. This produces relatively large drops in signal strength along the sample line in FIG. 14 and relatively large amounts of power distributed in the low frequency zone of the power spectrum as shown in FIG. 15.

Referring to FIG. 13, a light transmittance image is provided which was obtained using a micro visual cell apparatus (30) of the type shown in FIG. 4. The light transmittance image pertains to an oil sample containing a higher concentration of pentane solvent than the light transmittance image of FIG. 10. Further, FIG. 13 indicates the location of the 1D sample line (62) extending along the X-axis of the image.

FIG. 14 is a graphical representation of a light transmittance signal through the light transmittance image of FIG. 13 along the depicted sample line (62), in which the X-axis represents the horizontal position along the sample line and the Y-axis represents the intensity of light transmittance at a particular horizontal position. Further, FIG. 15 shows a one dimensional transform frequency domain power spectrum derived from the light transmittance signal of FIG. 14, in which the X-axis represents spatial frequency and the Y-axis represents power.

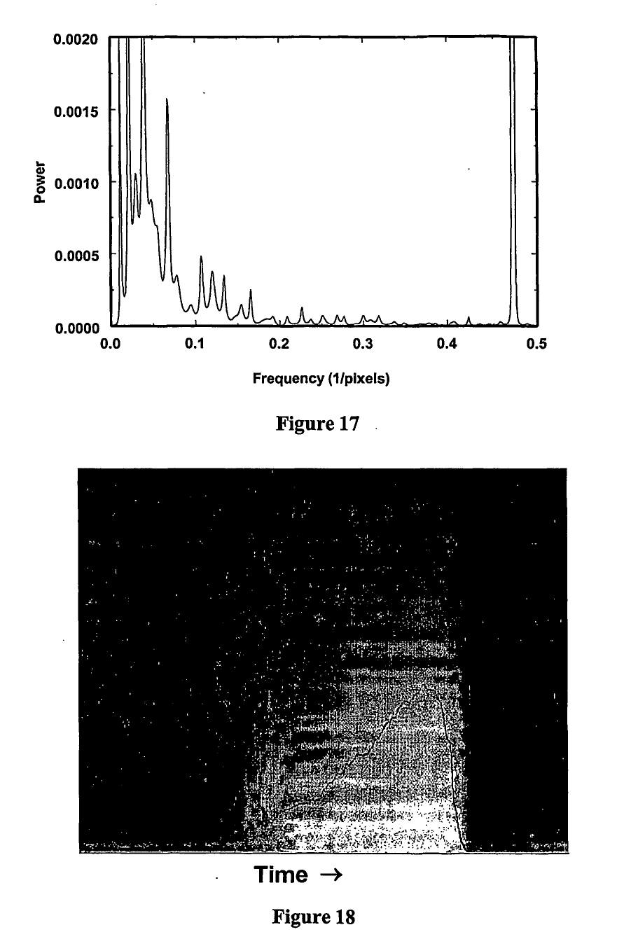

FIGS. 16 through 17 represent the cell when it has been cleaned using toluene. More particularly, FIG. 16 is a graphical representation of a light transmittance signal through a sample of toluene along a sample line in a light transmittance image (not shown), in which the X-axis represents the horizontal position along the sample line and the Y-axis represents the intensity of light transmittance at a particular horizontal position. FIG. 17 is a one dimensional frequency domain power spectrum derived from the light transmittance signal of FIG. 16, in which the X-axis represents spatial frequency and the Y-axis represents power.

The power spectrum shown in FIG. 17 has a different character than that found for 100% oil in FIG. 9. It is believed that the explanation for this observation is that solids are being observed which have been left on the windows, which solids are only visible when there is highly transparent fluid. As the local average has been subtracted from each point, the effect of the large signal strength in the clear cell has been removed. Thus, only the variation due to the solids left behind may be observed, which cannot be detected when the cell is full of oil.

FIG. 18 is presented as a 2D graphical representation of a typical sequence of one dimensional frequency domain power spectra derived from original domain data of the oil/solvent which could be obtained using the micro visual cell apparatus (30) of the type shown in FIG. 4. Referring to FIG. 18, the X-axis represents the pentane solvent ratio, the Y-axis represents spatial frequency in reciprocal cm and the Z-axis represents power, or in effect, the amount of size information at each image/time step and at each size expressed in reciprocal cm. Further, FIG. 18 includes an overlay curve in which the X-axis represents pentane solvent ratio and the Y-axis represents characterization number.

Although the data presented in FIG. 18 is presented as data from the micro visual cell apparatus (30), the data was obtained using a spectrophotometer (32) and is therefore presented as exemplary only. Actual equivalent data obtained using the micro visual cell apparatus (30) could be expected to be similar to that presented in FIG. 18.

Since these example images are made up of one dimensional samples from a given transmittance image, it is important to know that the statistical nature of such a sample represents a reasonable representation of the whole. However, to address this limitation, either all of the horizontal lines or a plurality of sample lines may be used, or as previously mentioned, a two dimensional transform such as a two dimensional transform may be used.

If a two dimensional FFT is used, the dimensions of the image must be a power of 2 in each direction. This may be achieved by one of the following two methods. The first method is to sample a square section of the image, which is the largest square, which can be extracted from a circular window. The second method is to use two dimensional linear interpolation and convert the rectangular aspect ratio (i.e. 640×480) to a 512×512 image. In either method, it has been found that little or no loss of sensitivity occurs due to the alteration of the aspect ratio of the images. In both methods, the aspect ratio into which the images is converted is preferably consistent for all images in a series of images.

Once this has been done, the two dimensional FFT can be computed. Once the sequence of images are converted to power spectra images, the total power integral found over the frequency range of choice may be computed. The frequency range of choice will depend on the range of sizes that are desired to be examined.

The images contain additional information about the distribution of the solids versus the liquid parts of the transmittance images. This information may be extracted from the histograms calculated from the series of transmittance images. The process used to extract this information is referred to as “Histogram Deconvolution.” Histogram Deconvolution uses non-linear Least Squares to fit a set of Gaussian curves to the histogram. The parameters from this set of equations may be used to extract information about the separate parts of each transmittance image.

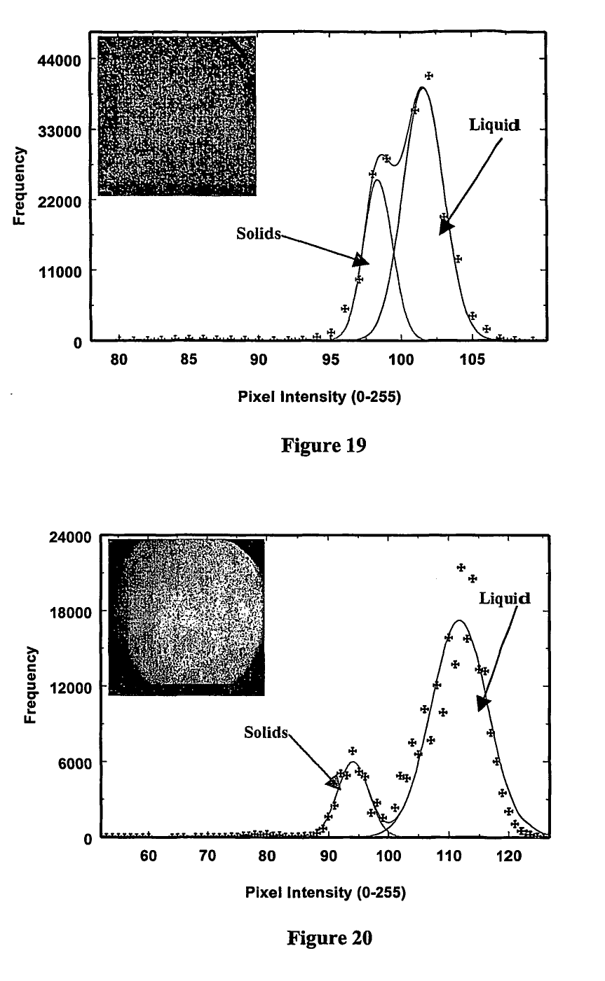

FIGS. 19 through 21 show three separate histograms and the transmittance image that each of them represents. The two Gaussian curves are plotted under each histogram. The parameter of interest here is the mode or the position of the peak maxima. If the mode value is plotted on the “x” axis for all images, two curves are provided which represent the modal intensity for the liquids and the modal intensity for the solids.

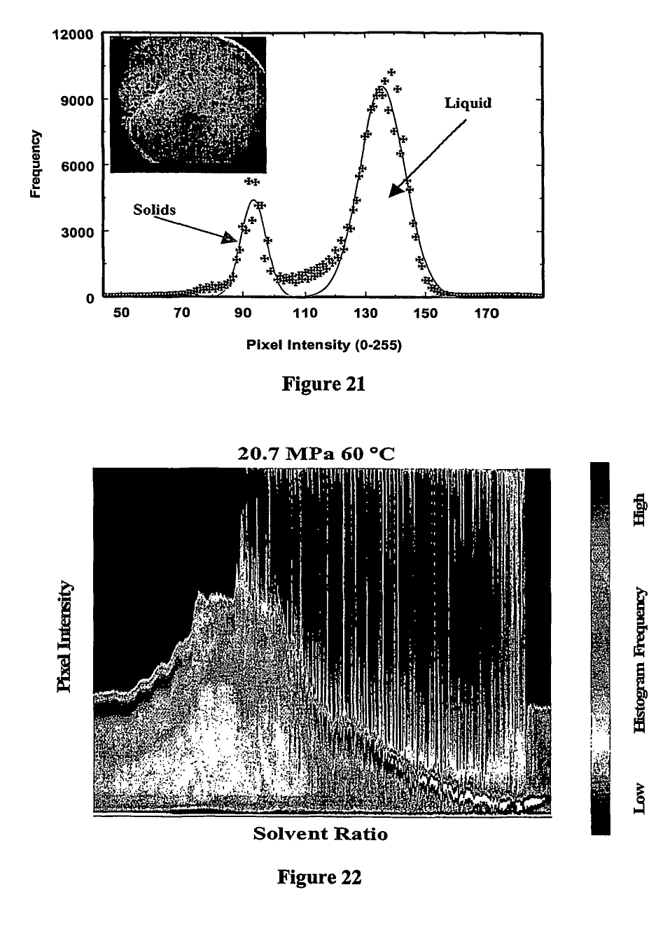

More particularly, FIG. 19 provides a light transmittance intensity histogram derived from the light transmittance image which is inset therein for an oil sample containing a minimal amount of precipitated asphaltene particles. FIG. 20 provides a light transmittance intensity histogram derived from the light transmittance image which is inset therein for an oil sample containing some precipitated asphaltene particles. FIG. 21 provides a light transmittance intensity histogram derived from the light transmittance image which is inset therein for an oil sample containing more precipitated asphaltene particles than the oil sample of FIG. 20. In each of FIGS. 19-21, the X-axis represents light transmittance intensity, the Y-axis represents frequency of a particular light transmittance intensity throughout the light transmittance image and the two curves represent modal intensity of liquid and solid phases.

Each of these modal intensity curves provides different information about the process. FIG. 22 plots these curves as an image where the x-axis represents the solvent concentration, the y-axis represents the histogram intensity and the z-axis represents the frequency. More particularly, FIG. 22 is a graphical representation of a sequence of light transmittance intensity histograms including those depicted in FIGS. 19-21, in which the X-axis represents pentane solvent ratio, the Y-axis represents light transmittance intensity and the Z-axis represents frequency of a particular light transmittance intensity throughout a light transmittance image.

It has been found that the liquid curve is most closely related to the total average light transmitted from the cell but it has had the effects of the solids removed. This means it is more related to dilution with the obvious caveat that as the asphaltenes are removed the amount of light transmitted goes up faster than by Beer's law dilution alone.

Further, with respect to the solids curve, it has been found that when the precipitation phase is just starting, the particles are small and do not produce something big enough to fill the space between the two glass windows (ca. 200 μm). As such, the intensity associated with these particles is higher than when the particles are larger or are adhering to the glass (as in deposition). Therefore the solids modal value tends to decrease as the asphaltenes become bigger and darker. This method allows these changes to be identified.

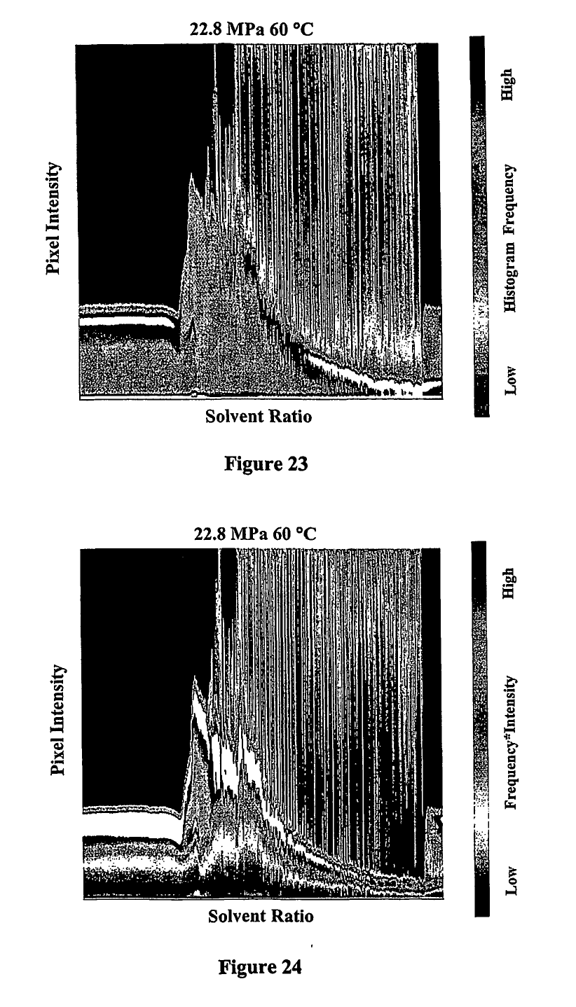

A further example is provided by FIGS. 23-26. In particular, FIG. 23 provides a graphical representation of a sequence of light transmittance intensity histograms derived from light transmittance images for oil samples at a pressure of 22.8 Mpa and at a temperature of 60 degrees Celsius, in which the X-axis represents CO₂ solvent ratio, the Y-axis represents light transmittance intensity and the Z-axis represents frequency of a particular light transmittance intensity throughout a light transmittance image. FIG. 24 provides a graphical representation of a sequence of light transmittance intensity histograms derived from light transmittance images for oil samples at a pressure of 22.8 Mpa and at a temperature of 60 degrees Celsius, in which the X-axis represents CO₂ solvent ratio, the Y-axis represents light transmittance intensity and the Z-axis represents the product of light transmittance intensity and frequency of the light transmittance intensity throughout a light transmittance image.

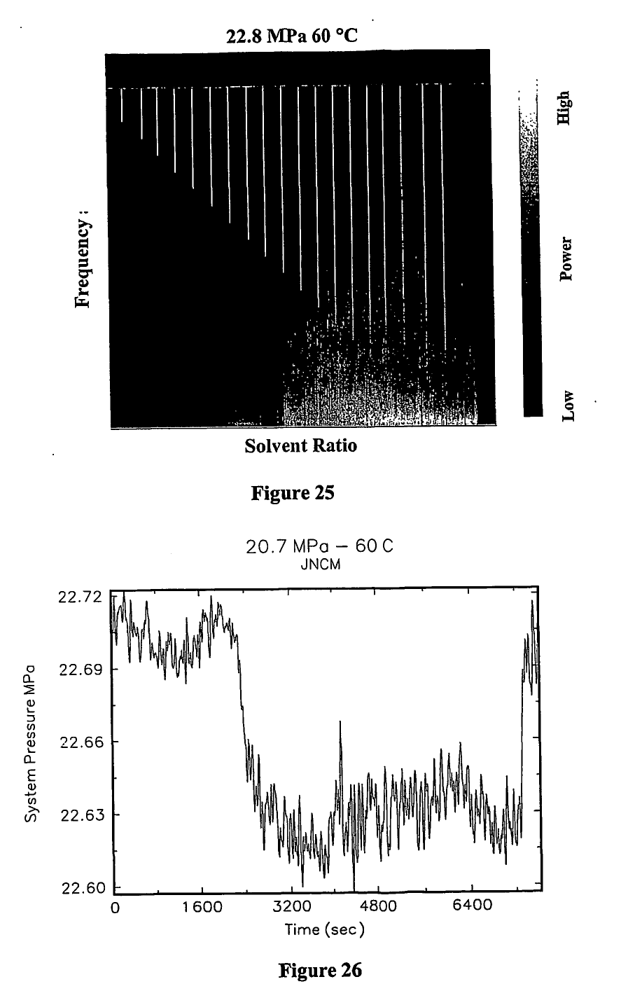

FIG. 25 provides a graphical representation of a sequence of frequency domain power spectra derived from oil sample data obtained using a spectrophotometer (32) of the type shown in FIG. 2 for oil samples at a pressure of 22.8 Mpa and at a temperature of 60 degrees Celsius, in which the X-axis represents CO₂ solvent ratio, the Y-axis represents temporal frequency and the Z-axis represents power.

FIG. 26 provides a graphical representation of a system pressure signal pertaining to the system pressure within the spectrophotometer (32) during the gathering of the oil sample data of FIG. 23, FIG. 24 and FIG. 25, in which the X-axis represents time and the Y-axis represents system pressure. The representation in FIG. 26 depicts how the system pressure signal exhibits pressure transients as the oil sample is passed through the spectrophotometer (32).

Further, as discussed above, the characterization number may be computed and used in the presentation of the data. Specifically, a characterization number may be computed for each of the frequency domain spectra generated from the transformed set of the original domain data. More particularly, as discussed above, each of the frequency domain power spectra may be integrated to obtain a characterization number. The characterization numbers may then be plotted to produce a characterization number curve which provides information permitting the prediction of the onset of precipitation, the agglomeration rate and the deposition stage.

For example, a sequence of characterization numbers may be calculated from the frequency domain power spectra shown in FIG. 25 and plotted on a characterization number curve as a function of the solvent/oil ratio. More particularly, FIG. 27 is a graphical representation of a sequence of characterization numbers calculated from the power spectra depicted in FIG. 25, in which the X-axis represents CO₂ solvent ratio and the Y-axis represents characterization number.

Further, as discussed previously, any suitable statistical tool may be utilized to normalize the characterization number curve to reduce the effects of aberrations in the data. For instance, FIG. 28 shows a modified version of a segment of the graphical representation of FIG. 27 which has been prepared using a multiple Gaussian function solved using non-linear least squares in which the X-axis represents CO₂ solvent ratio and the Y-axis represents characterization number.

As well, as discussed previously, a derivative may be calculated of the characterization number curve, being a derivative of the expression of the characterization number as a function of the dispersion characterizing variable such as oil/solvent ratio. The calculation of the derivative may be used to prepare a characterization number gradient curve which provides an expression of the slope of the characterization number curve. Again, if desired, any suitable statistical tool may be utilized to normalize the characterization number gradient curve to reduce the effects of aberrations in the data.

In addition, with respect to identification of the second liquid phase, the presence of the second liquid phase may be seen as the appearance of a significant number of pixels at maximum intensity; wherein the pixels represent the solvent bubbles that transmit light efficiently.

Various studies have been conducted on a wide range of oil samples, with solvents such as ethane, propane, butane, pentane and CO₂. In each case in which a second liquid phase appears when the solvent is no longer totally miscible in the oil, the asphaltene precipitation onset has occurred at a solvent concentration lower than the appearance of the second liquid phase. In general, it has been observed ,that it is the change in properties of the oil created by the loss of the asphaltenes that tends to change the solvent oil system from completely miscible to one in which the solvent concentration in the oil has reached saturation. An additional observation is that the solvent can, under these conditions, extract light ends from the oil and therefore cause the viscosity of the oil to increase substantially.

In the reservoir case it is important to note that this type of complex phase behavior is hard to depict accurately using phase behavior simulators alone. The existence of these transitions and the conditions at which they occur in quantitative terms may reduce the uncertainty of the design and operation of miscible systems in the field.

Discussed below are specific results obtained in a study conducted with respect to the CO₂ /crude oil system. The results were obtained using CO₂ as the solvent and at the pressure and temperature conditions set out in Table 1 below.

TABLE 1
Pressure and temperature conditions for
the CO₂- crude oil system tested

| 40° C. | 60° C. | 80° C. | 98° C. |
|---|---|---|---|
| | 14.5 MPa | | |
| | 15.8 MPa | 15.8 MPa | |
| 17.2 MPa | 17.2 MPa | 17.2 MPa | 17.2 MPa |
| | | 18.6 MPa | 18.6 MPa |
| | | | 20.0 MPa |

The temperature of 98.3° C. represents the reservoir temperature, while the pressure of 20 MPa (2900 psi) is the minimum miscibility pressure (MMP) for CO₂ with the live oil at reservoir temperature. The pressure and temperature conditions in Table 1 were chosen such that they represent the prevailing conditions at the CO₂ displacement front, around the production well and in the borehole, over a few hundred meters, when the oil-solvent mixture flows upward vertically in the production tubing. In the production tubing, during the natural flow, both temperature and pressure tend to decrease. An additional test at 40° C. was carried out to consolidate the conclusions. It is generally accepted that when the temperature decreases, there is a higher possibility of the appearance of a second liquid phase. Ann attempt was made to further confirm this.

The crude oil used in the studies had an asphaltene content of about 3.0 wt %. In all tests, dead oil of a viscosity of 11.8 mPas at 25° C. and 1000 psi was used. The viscosity decreased to 9.23 mPa·s at 40° C. and 3000 psi, and at 1.89 mPa·s at 100° C. and 3000 psi. The CO₂ MMP was 2900 psi (20 MPa) at 98.3° C. for the live crude oil having a bubble point pressure of 1000 psi and a solution gas-oil ratio of 300 scf/std. bbl.

Both the data obtained from the spectrophotometer (32) and the micro visual cell apparatus (30) was used to determine the concentration of CO₂ at which the precipitation of asphaltenes commenced.

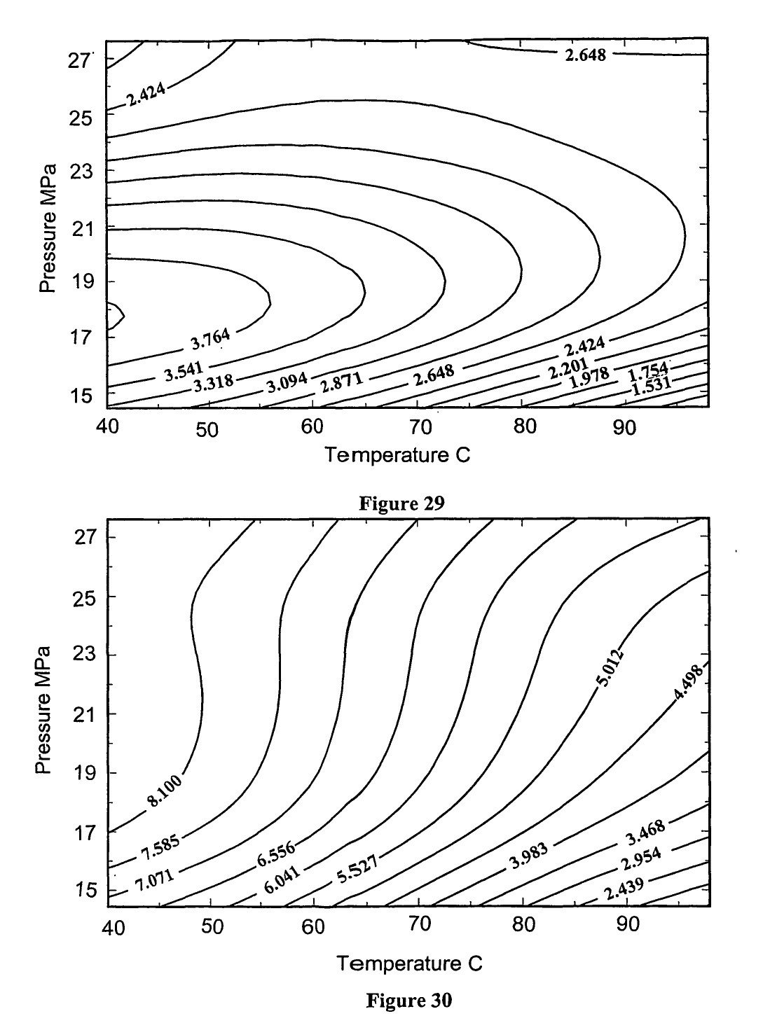

Referring generally to FIGS. 29-32, the onset of precipitation was determined by integrating the power spectrum with respect to frequency for each point on the time axis. Once the integral was obtained for each image, the portion representing the range from onset to deposition was fitted using a non-linear least squares model, based on the Gaussian integral (a algebraic sum of two or more scaled error functions). After normalizing the fitted curve, it is possible to determine the point on the time axis that corresponds to the region on the asphaltene image represented by the 5% value above the baseline.

Table 2 shows the flowing fraction of CO₂ corresponding to the onset points for asphaltene precipitation as well as for the formation of a second liquid phase (CO₂ rich phase). It should be noted that the flow rate was changed in steps every 5 minutes, which results in an error in the concentration of about ±2.5%. The two phase (the point where a clear CO₂ phase was first detected) boundary conditions were determined using the image data, where it was possible to identify the point at which two phases were present to the nearest image number (i.e. time).

TABLE 2
Onset of points of asphaltene precipitation and two-phase
formation, expressed as CO₂ flow fractions

| | | | | Onset of | Two-Phase |
|---|---|---|---|---|---|
| | | CO₂ | CO₂ | Precipitation | Onset |
| Temperature | Pressure | Compress- | Density | CO₂ Flow | CO₂ Flow |
| ° C. | MPa | ibility | gm/cc | Fraction | Fraction |
| 98.0 | 17.2 | 0.5954 | 0.4076 | 0.324 | 0.375 |
| 98.0 | 18.6 | 0.5838 | 0.4512 | 0.270 | 0.395 |
| 98.0 | 20.0 | 0.5783 | 0.4949 | 0.274 | 0.443 |
| 80.0 | 15.8 | 0.5138 | 0.4614 | 0.232 | 0.395 |
| 80.0 | 17.2 | 0.5020 | 0.5176 | 0.291 | 0.444 |
| 80.0* | 17.2 | 0.5020 | 0.5176 | 0.343 | 0.480 |
| 80.0 | 18.6 | 0.4992 | 0.5561 | 0.276 | 0.476 |
| 60.0 | 17.2 | 0.4084 | 0.6780 | 0.295 | 0.488 |
| 60.0 | 14.5 | 0.3990 | 0.5864 | 0.254 | 0.450 |
| 60.0 | 15.8 | 0.4000 | 0.6305 | 0.280 | 0.473 |
| 40.0 | 17.2 | 0.3575 | 0.8100 | 0.266 | 0.494 |

The flowing fraction data presented in Table 2 is the volume fraction of CO₂ for a total flow rate of 1.0 ml/min. This value may be converted to grams of CO₂, by using the density of CO₂ at each pressure and temperature, over the experimental region.

The results shown in Table 2 indicate that at lower temperatures, for the same pressure, a lower volumetric fraction of CO₂ is needed to reach the onset of asphaltene precipitation. At the same time, at lower temperatures, for the same pressure, a higher volumetric fraction of CO₂ is needed to reach the two-phase formation onset point (the appearance of CO₂ rich phase). Moreover, the fact that the appearance of the second liquid phase occurred at 98° C. and 20 MPa, as well, indicates that at these conditions first contact miscibility does not exist, when the volumetric CO₂ fractions are higher than 44%. This statement may also be considered in the context of a “vaporizing” mechanism for the dynamic miscible (multiple contact) displacement with CO₂ at this high temperature (98° C.).

The multiple contact miscibility condition tends to be more complex than first contact miscibility and requires intensive mass transfer of light hydrocarbons from the oil to the CO₂. Additional studies may be necessary in order to better understand this process.

The results of the studies tend to support the observation that flocculation or agglomeration is a continuous process and therefore it is difficult to determine a threshold for flocculation. A threshold for deposition may be determined from this data set with additional computation.

Referring to Table 3, the final concentrations of CO₂, for both the onset of precipitation and the boundary of the two-phase region, in moles/L are shown. The boundary of the two-phase region can be regarded as the bubble point pressure (saturation pressure) envelope in a Pressure-Temperature diagram; which is the phase equilibrium diagram of the CO₂-crude oil in a P-T diagram.

TABLE 3
Onset points of asphaltene precipitation and two-phase
formation, expressed as CO₂ Moles/Litre

| | | Onset of | Two Phase |
|---|---|---|---|
| Temperature | Pressure | Precipitation | Envelope |
| ° C. | MPa | Mole/l | Mole/l |
| 98.0 | 17.2 | 3.00 | 3.47 |
| 98.0 | 18.6 | 2.77 | 4.05 |
| 98.0 | 20.0 | 3.08 | 4.98 |
| 80.0 | 15.8 | 2.43 | 4.14 |
| 80.0 | 17.2 | 3.42 | 5.22 |
| 80.0* | 17.2 | 4.03 | 5.65 |
| 80.0 | 18.6 | 3.49 | 6.02 |
| 60.0 | 17.2 | 4.55 | 7.52 |
| 60.0 | 14.5 | 3.39 | 6.00 |
| 60.0 | 15.8 | 4.01 | 6.78 |
| 40.0 | 17.2 | 4.90 | 9.09 |

*Repeatability test

A correlation surface for each parameter presented in Table 3 may be constructed using a linear least squares polynomial surface. Both sets of data were successfully fitted with pressure and temperature as the independent variables, using a polynomial of order 2, with one cross term of order 1. The resulting surface for the onset of precipitation is shown in FIG. 29, as a contour graph showing the magnitude of the concentrations. Specifically, FIG. 29 is a contour graph depicting the onset of precipitation of asphaltene particles in oil samples for a range of CO₂ solvent concentrations, in which the X-axis represents temperature, the Y-axis represents pressure and each curve represents a particular CO₂ solvent concentration expressed in moles per litre.

The two-phase envelope and saturation pressure envelope are shown in FIG. 30. More particularly, FIG. 30 is a contour graph depicting the onset of the second liquid phase for oil samples having a range of CO₂ solvent concentrations, in which the X-axis represents temperature, the Y-axis represents pressure and each curve represents a particular CO₂ solvent concentration expressed in moles per litre.

Both data sets have a region where, due to the lack of experimental data points, the correlation surface cannot be relied on to extrapolate correctly. This region has been set to black in the images and in the contours a lower limit of 2.0 Moles/L has been used to define the lower limit. The correlation coefficient for the onset of precipitation is 0.928 and for the two-phase system is 0.99. Such a high correlation coefficient for both systems helps us overcome the 2.5% error for individual measurements.

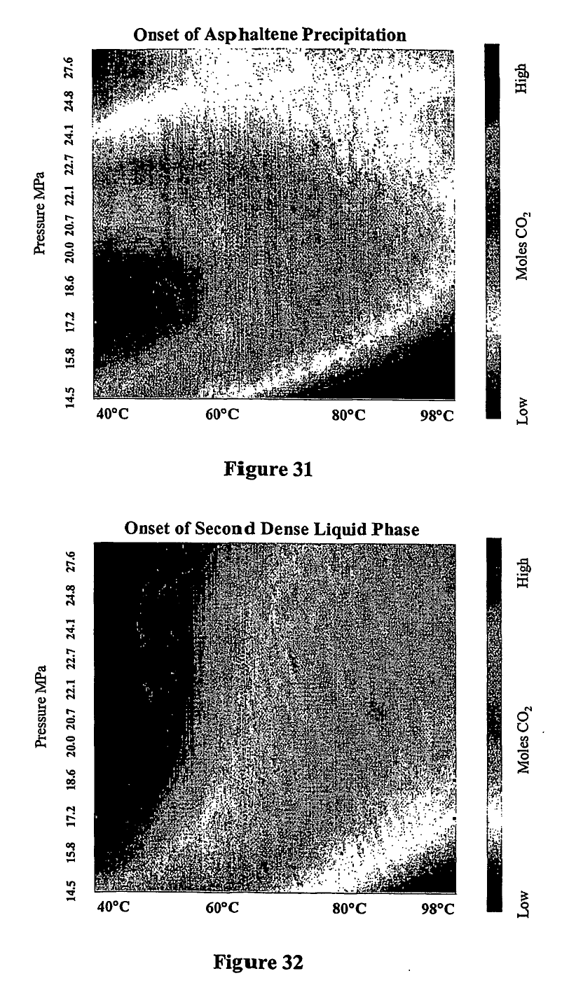

In FIGS. 31 and 32 the correlation surfaces have been converted into false color maps of the onset points with respect to temperature and pressure, where the color of the map represents the amount of CO₂ required to produce each effect. More particularly, FIG. 31 is a graphical representation of the contour graph of FIG. 29 in which the X-axis represents temperature, the Y-axis represents pressure and the Z-axis represents CO₂ solvent concentration expressed in moles per litre. Similarly, FIG. 32 is a graphical representation of the contour graph of FIG. 30 in which the X-axis represents temperature, the Y-axis represents pressure and the Z-axis represents CO₂ solvent concentration expressed in moles per litre.

The models used herein are based on the traditional chemical description of how solids precipitate from solutions, and then flocculate into agglomerates large enough to settle out of the liquid and deposit on the rock surface. The method of the within invention allows the determination of the onset of asphaltene precipitation to be determined quantitatively, while semi-quantitative information on flocculation rate and deposition conditions may be defined. Further, the studies described herein also permit the determination of the two-phase envelope in a Pressure-Temperature system.

The method described herein was developed based on a very detailed computational approach to the analysis of experimental data. This method allows changes in pseudo-continuous solvent/oil ratios. Further, it can generate one set of data in approximately one to two hours, discounting the time required to do the analysis (which can be done off-line). Thus, this methodology allows the study of multiple “pressure and temperature” steps in a relatively short time frame.

Further, the experimental data contains additional information about the rate of flocculation and the onset of deposition. Further calculations based on the model used to describe the relationship between characterization number and solvent/oil fraction may be required to achieve this end.

In addition, as discussed above, in the first preferred embodiment the attribute of the dispersion may be pressure so that the set of original domain data relates to pressure transients experienced by the dispersion as it experiences energy losses during flow through a channel or conduit. Thus, the collecting step of the method may be performed using one or more of the pressure transducers (36) as shown in FIG. 1.

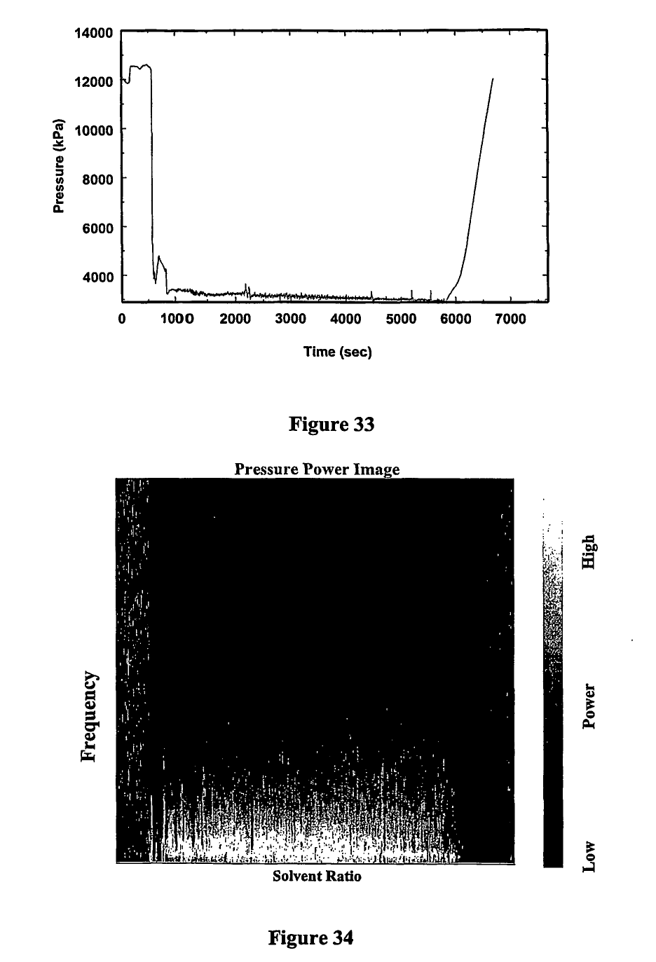

In this instance, the set of original domain data is preferably comprised of a pressure signal representing the pressure of the dispersion over a period of time and wherein variations in pressure represent pressure transients experienced by the dispersion. For example, FIG. 33 is a graphical representation of a typical system pressure signal depicting fluctuations in system pressure within a data collection system (20) of the type shown in FIG. 1 for oil samples having a particular solvent ratio, in which the X-axis represents time and the Y-axis represents system pressure.

The set of original domain data relating to pressure transients experienced by the dispersion may then be transformed into a transformed set of original domain data in the frequency domain. A frequency domain spectrum may then be generated from the transformed set of original domain data. For example, FIG. 34 is a graphical representation of a typical sequence of frequency domain power spectra derived from a series of system pressure signals obtained from oil samples having varying solvent ratios, in which the X-axis represents solvent ratio, the Y-axis represents temporal frequency and the Z-axis represents power of the pressure signal.

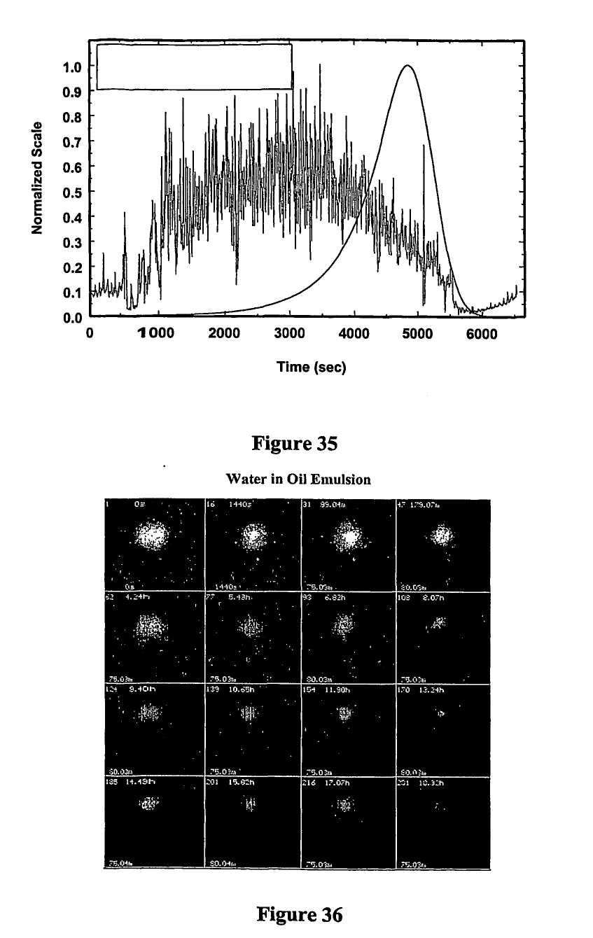

The frequency domain spectra may then be integrated, as discussed previously, to obtain a characterization number for each of the frequency domain spectra and plotted on a characterization number curve and normalized if desired. For example, FIG. 35 is a graphical representation of a sequence of characterization numbers calculated from the sequence of power spectra depicted in FIG. 34 in which the X-axis represents CO₂ solvent ratio and the Y-axis represents characterization number based upon system pressure signals. Further, FIG. 35 depicts an overlay curve in which the X-axis represents CO₂ solvent ratio and the Y-axis represents characterization number based upon light transmittance signals.

Finally, as discussed previously, in a second preferred embodiment the dispersion may be comprised of an emulsion, such as an oil in water emulsion or a water in oil emulsion and the method of the invention may be used to characterize the emulsion. In other words, the method described herein has been found to be equally applicable to the characterization of emulsions.

In connection with the second preferred embodiment a further study was conducted with respect to the characterization of emulsions in which the test apparatus was comprised of a single tube design microscope and a video camera for obtaining the original domain data relating to the emulsion. The video camera used in the further study was a cooled Charged Coupled Device (“CCD”) detector as cooled detectors tend to provide improved signal to noise ratios, and thus tend to be more sensitive.

In the further study, the emulsion samples were placed in a small well covered with a microscope slide and the changes in the emulsion were monitored with respect to time as the small droplets coalesced into larger ones. The microscope was calibrated using a standard calibration slide.

FIG. 36 is a representative set of sixteen light transmittance images obtained according to the second preferred embodiment using the microscope and video camera. The transmittance images depict a water in oil emulsion as the dispersed phase coalesces over time.

Although a microscope and slides were used in the further study pertaining to the second preferred embodiment, an apparatus similar to the micro visual cell apparatus (30) described above would more preferably be utilized in the second preferred embodiment. A micro visual cell design for use in the second preferred embodiment would likely require a lower pressure limit, a smaller gap between the opposed windows and very thin sapphire windows in comparison with the micro visual cell apparatus (30).

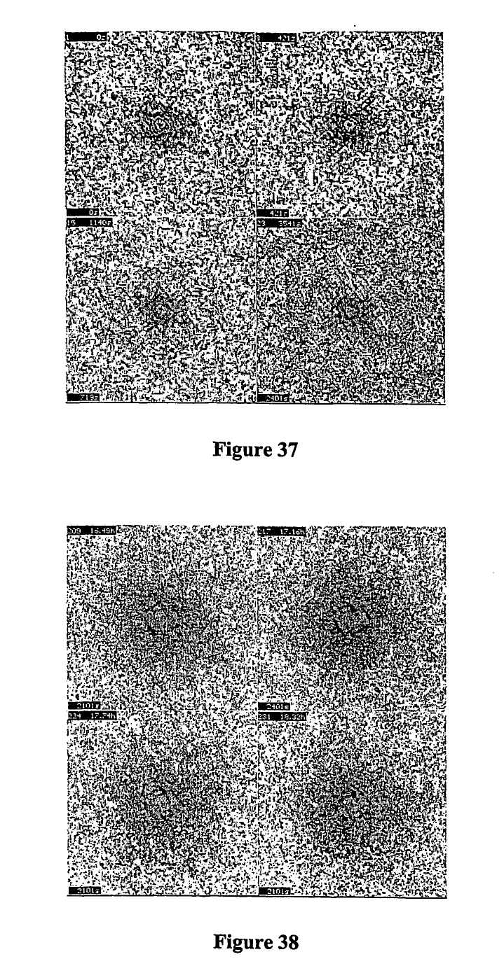

In the second preferred embodiment relating to the characterization of emulsions, a two dimensional transform is preferably performed on the set of original domain data to provide the transformed set of original domain data. In particular, the two dimensional transform is preferably a two dimensional FFT. Frequency domain spectra are then generated from the transformed set of original domain data. In this regard, FIG. 37 provides a representative set of four two dimensional frequency domain power spectra derived from light transmittance images of the type depicted in FIG. 36. FIG. 38 provides a further representative set of four two dimensional frequency domain power spectra derived from light transmittance images of the type depicted in FIG. 36.

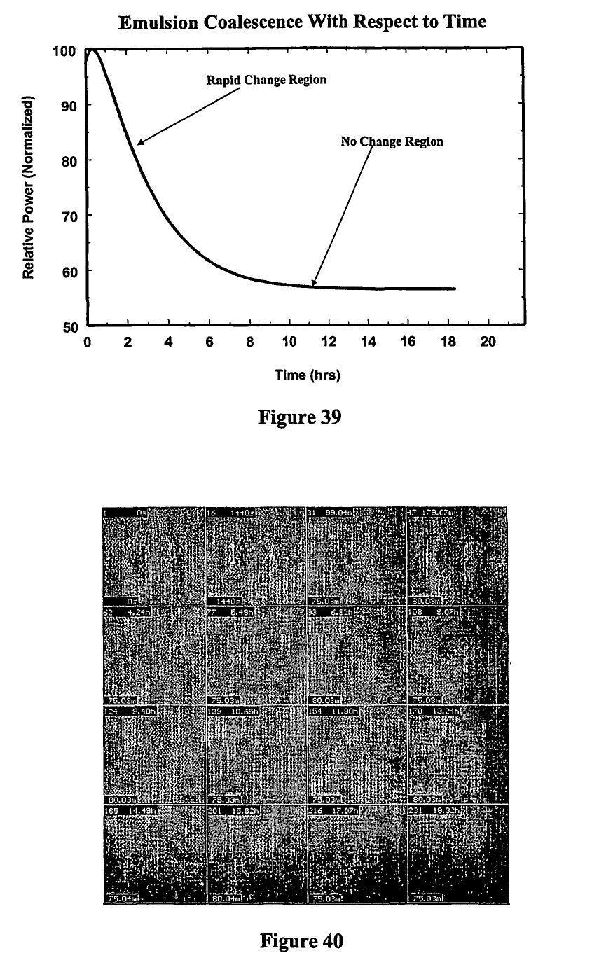

The frequency domain spectra may then be integrated, as discussed previously, to obtain a characterization number for each of the frequency domain spectra and plotted on a characterization number curve and normalized if desired. For example, FIG. 39 is a graphical representation of a sequence of characterization numbers calculated from 2D power spectra such as those depicted in FIGS. 37 and 38, in which the X-axis represents time and the Y-axis represents characterization number.

The resulting curve of FIG. 39 shows that the energy from the multiple edges of the small particles tends to decrease with time as the number of small droplets merge with the large droplet, and the gravity separation between oil and water is improved. Further, in reviewing the curve of FIG. 39, it is observed that the curve does not reach zero. It is believed that the reason for this observation is the presence of a DC component and/or a very low frequency component in the set of original domain data which is not accounted for unless the conditioning step is performed on the set of original domain data.

In order to reduce the DC component, a derivative of the set of original domain data is preferably calculated in one dimension for a one dimensional transform or in two dimensions for a two dimensional transform. The result of this action is to remove or reduce the DC component of the image and thus remove much of the information related to the DC component.

For example, FIG. 40 is a view of derivative images of the sixteen light transmittance images depicted in FIG. 36 in which the derivatives of the light transmittance images have been taken along the X-axis in order to reduce the DC component.

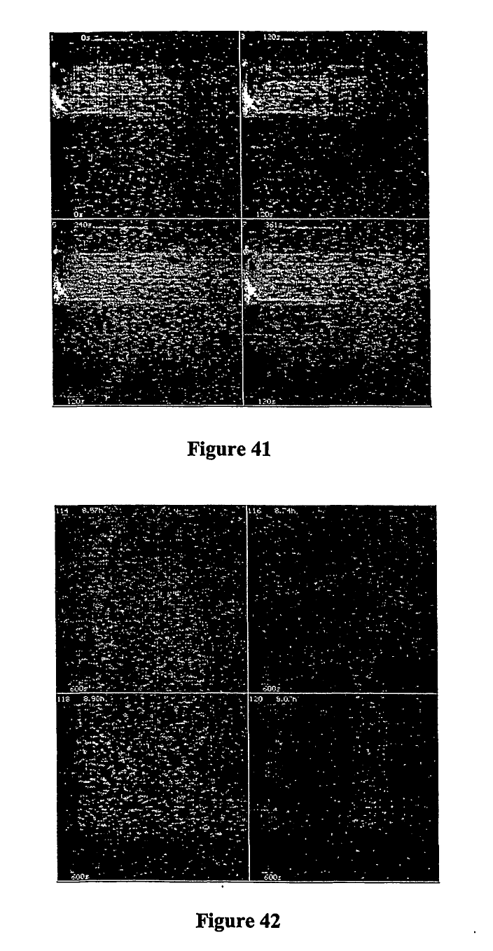

Further, FIGS. 41 and 42 each provide a graphical representation of four composite one dimensional frequency domain power spectra derived from derivatives of four light transmittance images of the type depicted in FIG. 40. Referring to FIGS. 41 and 42, each of the four composite one dimensional frequency domain power spectra has been derived from a series of sample lines taken along the X-axis of the derivative of the light transmittance image to produce a composite power spectra which includes light transmittance data from each of the sample lines, in which the X-axis represents spatial frequency and brightness represents power.

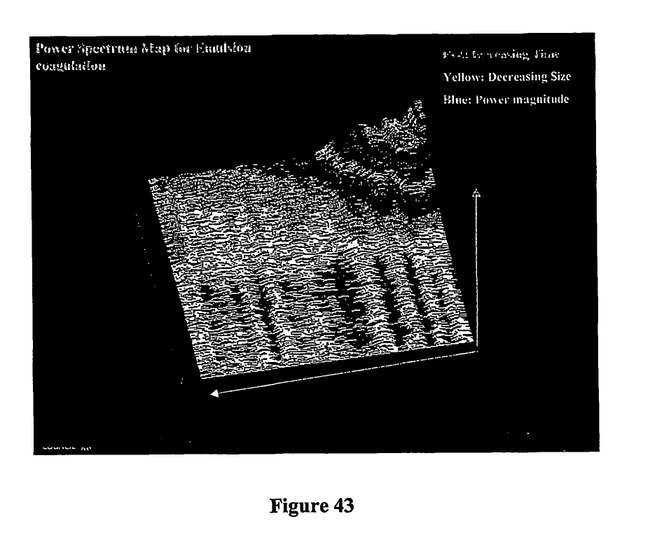

These images show that the maximum energy content of the images tends to decrease in both frequency and magnitude with respect to time. FIG. 43 shows a plot of these factors as a three dimensional map in order to emphasize this dynamic change. The high background content of the power images was compensated for by dividing all of the images by the last image in the sequence. Accordingly, FIG. 43 provides a graphical representation of a typical sequence of one dimensional frequency domain power spectra of the type depicted in FIGS. 41 and 42, in which the X axis represents time, the Y-axis represents spatial frequency and the Z-axis represents average power derived from a series of sample lines at a particular time and spatial frequency.

1. A method for analyzing a dispersion comprising the following steps:
(a) collecting a set of original domain data relating to an attribute of the dispersion;
(b) transforming the set of original domain data into a transformed set of original domain data, wherein the transformed set of original domain data is in the frequency domain; and
(c) characterizing the dispersion using the transformed set of original domain data.

2. The method as claimed in claim 1, further comprising the step of generating a frequency domain spectrum from the transformed set of original domain data, wherein the frequency domain spectrum expresses a parameter relating to the attribute of the dispersion as a function of frequency and wherein the characterizing step is performed using the frequency domain spectrum.

3. The method as claimed in claim 2 wherein the attribute of the dispersion is pressure of the dispersion.

4. The method as claimed in claim 2 wherein the attribute of the dispersion is transmittance of electromagnetic radiation through the dispersion.

5. The method as claimed in claim 4 wherein the set of original domain data is comprised of a transmittance signal representing transmittance of electromagnetic radiation through the dispersion over a period of time.

6. The method as claimed in claim 5, further comprising the step of manipulating the dispersion during the period of time in order to cause variations in the transmittance signal over the period of time.

7. The method as claimed in claim 6 wherein the collecting step is performed using a data collection apparatus comprising a transmittance sensor and wherein the manipulating step is comprised of moving the dispersion and the transmittance sensor relative to each other.

8. The method as claimed in claim 7 wherein the manipulating step is comprised of moving the dispersion through a conduit past the transmittance sensor.

9. The method as claimed in claim 8 wherein the data collection apparatus is further comprised of a source of electromagnetic radiation and wherein the manipulating step is comprised of moving the dispersion through the conduit between the source of electromagnetic radiation and the transmittance sensor.

10. The method as claimed in claim 2 wherein the transforming step is comprised of transforming the set of original domain data in one dimension.

11. The method as claimed in claim 10, further comprising the step of conditioning the set of original domain data before the transforming step in order to reduce at least one unwanted component in the set of original domain data.

12. The method as claimed in claim 11 wherein the conditioning step is comprised of calculating a derivative of the set of original domain data in one dimension.

13. The method as claimed in claim 2 wherein the transforming step is comprised of transforming the set of original domain data in two dimensions.

14. The method as claimed in claim 13, further comprising the step of conditioning the set of original domain data before the transforming step in order to reduce at least one unwanted component in the set of original domain data.

15. The method as claimed in claim 14 wherein the conditioning step is comprised of calculating a derivative of the set of original domain data in two dimensions.

16. The method as claimed in claim 2 wherein the collecting step is comprised of collecting a plurality of subsets of original domain data so that the set of original domain data is comprised of the subsets of original domain data, wherein the subsets of original domain data are transformed into a plurality of subsets of transformed original domain data, and wherein the characterizing step is performed using the subsets of transformed original domain data.

17. The method as claimed in claim 16 wherein the frequency domain spectrum generating step is comprised of generating a frequency domain spectrum from each of the subsets of transformed original domain data in order to produce a plurality of frequency domain spectra and wherein the characterizing step is performed using the frequency domain spectra.

18. The method as claimed in claim 17 wherein the collecting step is comprised of collecting each of the subsets of original domain data at a different value of a dispersion characterizing variable so that the dispersion may be characterized with respect to the dispersion characterizing variable.

19. The method as claimed in claim 18 wherein the dispersion is comprised of oil and wherein the dispersion characterizing variable is an amount of solvent mixed with the oil.

20. The method as claimed in claim 18 wherein the dispersion is comprised of an emulsion comprising oil and water and wherein the dispersion characterizing variable is time.

21. The method as claimed in claim 18 wherein the dispersion is comprised of an emulsion comprising oil and water and wherein the dispersion characterizing variable is a ratio of the relative amounts of oil and water contained in the emulsion.

22. The method as claimed in claim 18 wherein the characterizing step is comprised of the step of generating from the frequency domain spectra an expression of the parameter relating to the attribute of the dispersion as a function of both frequency and the dispersion characterizing variable in order to characterize the dispersion with respect to the dispersion characterizing variable.

23. The method as claimed in claim 22 wherein the transforming step is comprised of transforming the set of original domain data in one dimension.

24. The method as claimed in claim 23, further comprising the step of conditioning the set of original domain data before the transforming step in order to reduce at least one unwanted component in the set of original domain data.

25. The method as claimed in claim 24 wherein the conditioning step is comprised of calculating a derivative of the set of original domain data in one dimension.

26. The method as claimed in claim 18 wherein the characterizing step is comprised of the step of integrating each of the frequency domain spectra between an upper selected frequency and a lower selected frequency, thereby obtaining a characterization number for each of the frequency domain spectra.

27. The method as claimed in claim 26 wherein the characterizing step is further comprised of the step of generating from the characterization numbers an expression of characterization number as a function of the dispersion characterizing variable in order to characterize the dispersion with respect to the dispersion characterizing variable.

28. The method as claimed in claim 27 wherein the characterizing step is further comprised of calculating a derivative of the expression of characterization number as a function of the dispersion characterizing variable in order to characterize the dispersion with respect to the dispersion characterizing variable.

29. The method as claimed in claim 27 wherein the transforming step is comprised of transforming the set of original domain data in one dimension.

30. The method as claimed in claim 29, further comprising the step of conditioning the set of original domain data before the transforming step in order to reduce at least one unwanted component in the set of original domain data.

31. The method as claimed in claim 30 wherein the conditioning step is comprised of calculating a derivative of the set of original domain data in one dimension.

32. The method as claimed in claim 27 wherein the transforming step is comprised of transforming the set of original domain data in two dimensions.

33. The method as claimed in claim 32, further comprising the step of conditioning the set of original domain data before the transforming step in order to reduce at least one unwanted component in the set of original domain data.

34. The method as claimed in claim 33 wherein the conditioning step is comprised of calculating a derivative of the set of original domain data in two dimensions.

35. The method as claimed in claim 4 wherein the set of original domain data is comprised of a transmittance image representing distribution of transmittance of electromagnetic radiation through the dispersion over a spatial area.

36. The method as claimed in claim 35 wherein the transforming step is comprised of transforming the set of original domain data in one dimension along a sample line.

37. The method as claimed in claim 36, further comprising the step of conditioning the set of original domain data before the transforming step in order to reduce at least one unwanted component in the set of original domain data.

38. The method as claimed in claim 37 wherein the conditioning step is comprised of calculating a derivative of the set of original domain data in one dimension.

39. The method as claimed in claim 35 wherein the transforming step is comprised of transforming the set of original domain data in one dimension along a plurality of sample lines.

40. The method as claimed in claim 39, further comprising the step of conditioning the set of original domain data before the transforming step in order to reduce at least one unwanted component in the set of original domain data.

41. The method as claimed in claim 40 wherein the conditioning step is comprised of calculating a derivative of the set of original domain data in one dimension.

42. The method as claimed in claim 41 wherein the step of generating the frequency domain spectrum from the transformed set of original domain data is comprised of determining from the plurality of sample lines an average value for the parameter relating to the attribute of the dispersion as a function of frequency.

43. The method as claimed in claim 35 wherein the transforming step is comprised of transforming the set of original domain data in two dimensions.

44. The method as claimed in claim 43, further comprising the step of conditioning the set of original domain data before the transforming step in order to reduce at least one unwanted component in the set of original domain data.

45. The method as claimed in claim 44 wherein the conditioning step is comprised of calculating a derivative of the set of original domain data in two dimensions.
